(19) United States
(12) Patent Application Publication
(10) Pub. No.: US 2026/0025597 A1
(43) Pub. Date: Jan. 22, 2026

(54) PHOTOELECTRIC CONVERSION DEVICE AND METHOD OF DRIVING PHOTOELECTRIC CONVERSION DEVICE

(71) Applicant: CANON KABUSHIKI KAISHA, Tokyo (JP)

(72) Inventor: SHUHEI HAYASHI, Kanagawa (JP)

(21) Appl. No.: 19/265,774

(22) Filed: Jul. 10, 2025

(30) Foreign Application Priority Data
Jul. 19, 2024 (JP) 2024-115764
Apr. 10, 2025 (JP) 2025-065113

(51) Int. Cl. H04N 25/59; G06T 7/55; H04N 25/77

(52) U.S. Cl. CPC H04N 25/59; G06T 7/55; H04N 25/77; G06T 2207/30252

(57) ABSTRACT

A photoelectric conversion device includes a photoelectric conversion unit that generates charge in response to incidence of light, a first charge holding portion, a second charge holding portion, a transfer unit that transfers the charge of the photoelectric conversion unit to the first charge holding portion in response to a control signal to a control node, a switch that controls a connection between the first charge holding portion and the second charge holding portion, a capacitor configured by an electrostatic coupling between a first interconnection connected to the control node and a second interconnection arranged adjacent to the first interconnection and connected to the second charge holding portion, and an output unit that outputs a signal corresponding to a potential of the first charge holding portion.

### BACKGROUND

### Field of the Technology

The present disclosure relates to a photoelectric conversion device and a method of driving a photoelectric conversion device.

### Description of the Related Art

Japanese Patent Laid-Open No. 2022-104203 describes an imaging device configured to provide a capacitive coupling wiring capacitively coupled to a floating diffusion and adjust a charge holding capacitance of the floating diffusion by a voltage of a signal applied to the capacitive coupling wiring. According to the imaging device described in Japanese Patent Laid-Open No. 2022-104203, it is possible to acquire an image with a high dynamic range by switching the conversion efficiency of the pixel by the charge holding capacitance of the floating diffusion.

However, in the imaging device described in Japanese Patent Laid-Open No. 2022-104203, since a control circuit for adjusting a signal to be applied to the capacitive coupling wiring is required, there is a concern that the circuit density further increases together with an increase in interconnection density due to the addition of the capacitive coupling wiring. For this reason, particularly in the case of an imaging device having a small pixel size, there is a possibility that the yield of the interconnection and the circuit deteriorates and the manufacturing cost increases.

### SUMMARY

According to an aspect of the present disclosure, there is provided a technique for realizing a circuit configuration for acquiring an image of a high dynamic range at low cost in a photoelectric conversion device.

According to one aspect of the present specification, there is provided a photoelectric conversion device including a photoelectric conversion unit configured to generate charge in response to incidence of light, a first charge holding portion, a second charge holding portion, a transfer unit configured to transfer the charge in the photoelectric conversion unit to the first charge holding portion in response to a control signal to a control node, a switch configured to control a connection between the first charge holding portion and the second charge holding portion, a capacitor configured by an electrostatic coupling between a first interconnection connected to the control node and a second interconnection arranged adjacent to the first interconnection and connected to the second charge holding portion and an output unit configured to output a signal corresponding to a potential of the first charge holding portion.

In addition, according to another disclosure of the present specification, there is provided a photoelectric conversion device including a photoelectric conversion unit configured to generate charge in response to incidence of light, a first charge holding portion, a second charge holding portion, a transfer unit configured to transfer the charge in the photoelectric conversion unit to the first charge holding portion in response to a control signal to a control node, a switch configured to control a connection between the first charge holding portion and the second charge holding portion, a capacitor of a MIM-type or a MOM-type connected between the control node and the second charge holding portion, and an output unit configured to output a signal corresponding to a potential of the first charge holding portion.

Further, according to still another disclosure of the present specification, there are provided a method of driving a photoelectric conversion device including first and second photoelectric conversion units each configured to generate charge in response to incidence of light, first and second charge holding portions, a first transfer unit configured to transfer the charge in the first photoelectric conversion unit to the first charge holding portion in response to a control signal to a control node, a second transfer unit configured to transfer the charge in the second photoelectric conversion unit to the first charge holding portion in response to a control signal to a control node, a switch configured to control a connection between the first charge holding portion and the second charge holding portion, a first capacitor configured by an electrostatic coupling between a first interconnection connected to the control node of the first transfer unit and a second interconnection arranged adjacent to the first interconnection and connected to the second charge holding portion, a second capacitor configured by an electrostatic coupling between the second interconnection and a third interconnection arranged adjacent to the second interconnection and connected to the control node of the second transfer unit, and an output unit configured to output a signal corresponding to a potential of the first charge holding portion, the method including changing a potential of the first charge holding portion by a capacitive coupling by the first capacitor and transferring charge held in the first photoelectric conversion unit to the first charge holding portion, by driving the first transfer unit in a state in which the switch is on, to output a signal corresponding to a potential of the first charge holding portion from the output unit, and changing the potential of the first charge holding portion by a capacitive coupling by the first capacitor and the second capacitor and transferring charge held in the first photoelectric conversion unit and the second photoelectric conversion unit to the first charge holding portion, by driving the first transfer unit and the second transfer unit in a state in which the switch is on, to output a signal corresponding to the potential of the first charge holding portion from the output unit.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a schematic configuration of a photoelectric conversion device according to a first embodiment.

FIG. 2 is an equivalent circuit diagram illustrating a configuration example of a pixel of the photoelectric conversion device according to the first embodiment.

FIG. 3 is a timing chart illustrating the operation of the pixel of the photoelectric conversion device according to the first embodiment.

FIG. 4 is an equivalent circuit diagram illustrating a configuration example of a pixel of a photoelectric conversion device according to a second embodiment.

FIG. 5 is a timing chart illustrating the operation of the pixel of the photoelectric conversion device according to the second embodiment.

FIG. 6 is an equivalent circuit diagram illustrating a configuration example of a pixel of a photoelectric conversion device according to a third embodiment.

FIG. 7A is a plan view illustrating an arrangement example of photoelectric conversion units of the pixel of the photoelectric conversion device according to the third embodiment.

FIG. 7B is a cross-sectional view illustrating an arrangement example of the photoelectric conversion units of the pixel of the photoelectric conversion device according to the third embodiment.

FIG. 8 is a timing chart illustrating the operation of the pixel of the photoelectric conversion device according to the third embodiment.

FIG. 9 and FIG. 10 are plan views illustrating layout examples of the pixels of the photoelectric conversion device according to the third embodiment.

FIG. 11 is an equivalent circuit diagram illustrating a configuration example of a pixel of a photoelectric conversion device according to a fourth embodiment.

FIG. 12 is a plan view illustrating a layout example of pixels of the photoelectric conversion device according to the fourth embodiment.

FIG. 13 is a block diagram illustrating a schematic configuration of an imaging system according to a fifth embodiment.

FIG. 14A is a diagram illustrating a configuration example of an imaging system according to a sixth embodiment.

FIG. 14B is a diagram illustrating a configuration example of a movable object according to the sixth embodiment.

FIG. 15 is a block diagram illustrating a schematic configuration of an equipment according to a seventh embodiment.

### DESCRIPTION OF THE EMBODIMENTS

Hereinafter, embodiments of the present technology will be described with reference to the drawings. In each of the embodiments described below, as an example of the photoelectric conversion device, a device used for imaging will be mainly described. However, each embodiment is not limited to the device used for the imaging application and may be applied to other examples included in the photoelectric conversion devices. For example, there are a distance measuring device (device for focus detection, distance measurement using time of flight (TOF), and the like) and a photometric device (device for measuring the amount of incident light).

In the following embodiments, connection between elements of a circuit may be described. In this case, even when another element is interposed between the elements of interest, the elements of interest are treated as being connected to each other unless otherwise specified. For example, an element A is connected to one node of a capacitor C having a plurality of nodes, and an element B is connected to the other node. Even in such a case, the element A and the element B are regarded as being connected to each other unless otherwise specified.

### First Embodiment

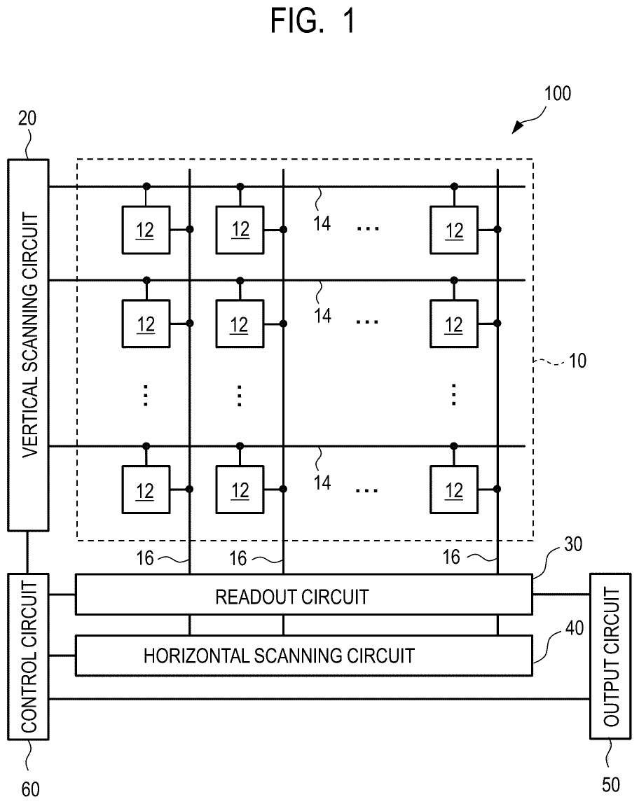

A schematic configuration of a photoelectric conversion device according to a first embodiment will be described with reference to FIG. 1. FIG. 1 is a block diagram illustrating a schematic configuration of a photoelectric conversion device according to the present embodiment.

As illustrated in FIG. 1, the photoelectric conversion device 100 according to the present embodiment includes a pixel unit 10, a vertical scanning circuit 20, a readout circuit 30, a horizontal scanning circuit 40, an output circuit 50, and a control circuit 60. The pixel unit 10 is connected to the vertical scanning circuit 20 and the readout circuit 30. The readout circuit 30 is connected to the horizontal scanning circuit 40 and the output circuit 50. The control circuit 60 is connected to the vertical scanning circuit 20, the readout circuit 30, the horizontal scanning circuit 40, and the output circuit 50.

The pixel unit 10 is provided with a plurality of pixels 12 arranged in a matrix so as to form a plurality of rows and a plurality of columns. Each pixel 12 includes a photoelectric conversion unit including a photoelectric conversion element such as a photodiode, and outputs a pixel signal according to the amount of incident light. The number of rows and the number of columns of the pixel array arranged in the pixel unit 10 are not particularly limited. In addition to an effective pixel that outputs a pixel signal according to the amount of incident light, an optical black pixel in which a photoelectric conversion unit is shielded from light, a dummy pixel that does not output a signal, or the like may be arranged in the pixel unit 10.

In each row of the pixel unit 10, a control line 14 is arranged so as to extend in a first direction (lateral direction in FIG. 1). Each of the control lines 14 is connected to the pixels 12 arranged in the first direction on the corresponding row and forms a signal line common to these pixels 12. Each of the control lines 14 may include a plurality of signal lines. The control lines 14 are connected to the vertical scanning circuit 20. The first direction in which the control lines 14 extend may be referred to as a row direction or a horizontal direction.

In each column of the pixel unit 10, an output line 16 is arranged so as to extend in a second direction (vertical direction in FIG. 1) intersecting the first direction. Each of the output lines 16 is connected to the pixels 12 arranged in the second direction on the corresponding column and forms a signal line common to these pixels 12. Each of the output lines 16 may include a plurality of signal lines. The output lines 16 are connected to the readout circuit 30. The second direction in which the output line 16 extends may be referred to as a column direction or a vertical direction.

The vertical scanning circuit 20 has a function of generating a control signal for driving the pixels 12 in response to a control signal from the control circuit 60. The vertical scanning circuit 20 drives the plurality of pixels 12 arranged in the pixel unit 10 in units of rows by supplying the generated control signal via the control line 14 of each row of the pixel unit 10. The vertical scanning circuit 20 may be configured using a shift register or an address decoder. The signals read out from the pixels 12 in units of rows are input to the readout circuit 30 via the output lines 16 of respective columns.

The readout circuit 30 has a function of holding the pixel signal read out from the pixel unit 10 and may have a function of performing predetermined signal processing on the pixel signal. Examples of the signal processing for the pixel signal include amplification processing, correction processing by correlated double sampling (CDS), addition processing, and analog-to-digital (A/D) conversion processing. The readout circuit 30 may include a column amplifier, a CDS circuit, an adder circuit, an A/D conversion circuit, and the like. Further, the readout circuit 30 includes a signal holding unit for holding the pixel signals of the respective columns received from the pixel unit 10 or the pixel signals of the respective columns after the signal processing.

The horizontal scanning circuit 40 has a function of generating a control signal for transferring the pixel signal held by the readout circuit 30 to the output circuit 50 in response to a control signal from the control circuit 60. The horizontal scanning circuit 40 sequentially supplies the generated control signals to the signal holding units of the respective columns of the readout circuit 30. Accordingly, the readout circuit 30 sequentially transfers the pixel signals held by the signal holding units of the respective columns to the output circuit 50. The horizontal scanning circuit 40 may be configured using a shift register or an address decoder.

The output circuit 50 may include a signal processing circuit that performs predetermined signal processing on the pixel signals sequentially transferred from the readout circuit 30, and an external interface circuit that outputs the processed pixel signals to the outside of the photoelectric conversion device 100. Examples of the signal processing circuit that may be included in the output circuit 50 include a buffer amplifier and a differential amplifier. Examples of the signal processing performed by the output circuit 50 include correction processing by CDS, amplification processing, and high dynamic range (HDR) composition processing. The external interface circuit included in the output circuit 50 is not particularly limited. As the external interface circuit, for example, a SERializer/DESerializer (SerDes) transmission circuit such as a Low Voltage Differential Signaling (LVDS) circuit or a Scalable Low Voltage Signaling (SLVS) circuit may be applied.

The control circuit 60 has a function of supplying control signals for controlling operations and timings of the vertical scanning circuit 20, the readout circuit 30, the horizontal scanning circuit 40, and the output circuit 50 to these functional blocks. Some or all of the control signals supplied to these functional blocks may be supplied from the outside of the photoelectric conversion device 100.

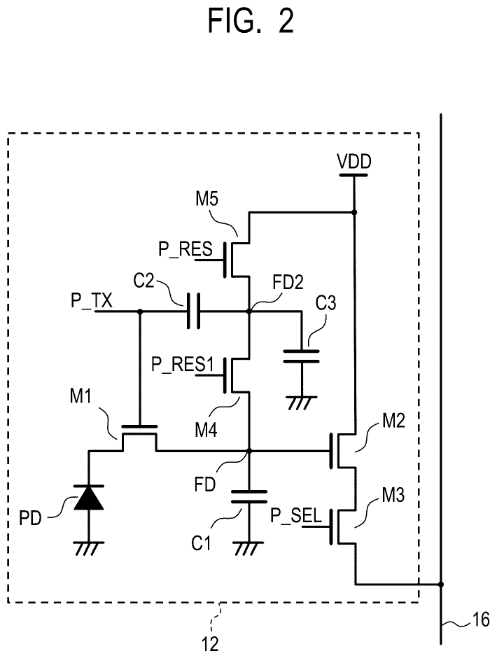

Next, a configuration example of the pixel 12 in the photoelectric conversion device according to the present embodiment will be described with reference to FIG. 2. FIG. 2 is an equivalent circuit diagram illustrating a configuration example of the pixel in the photoelectric conversion device according to the present embodiment.

As illustrated in FIG. 2, each of the pixels 12 constituting the pixel unit 10 may include a photoelectric conversion unit PD, a transfer transistor M1, an amplifier transistor M2, a select transistor M3, a reset transistor M4, and a reset transistor M5. The photoelectric conversion unit PD may be configured by a photoelectric conversion element, for example, a photodiode. The transfer transistor M1, the amplifier transistor M2, the select transistor M3, and the reset transistors M4 and M5 may be MOS transistors. The pixel 12 may further include a microlens and a color filter disposed on an optical path until incident light is guided to the photoelectric conversion unit PD. The microlens condenses incident light on the photoelectric conversion unit PD. The color filter selectively transmits light of a predetermined color.

The photoelectric conversion unit PD has an anode connected to the ground node and a cathode connected to a source of the transfer transistor M1. A drain of the transfer transistor M1 is connected to a gate of the amplifier transistor M2 and a source of the reset transistor M4. A connection node between the drain of the transfer transistor M1, the gate of the amplifier transistor M2, and the source of the reset transistor M4 is a so-called floating diffusion FD. The floating diffusion FD includes a capacitance component (floating diffusion capacitance) and has a function as a charge holding portion. In FIG. 2, this capacitance component is represented by a capacitor C1. Although one electrode of the capacitor C1 is connected to the ground node in FIG. 2, the capacitance component associated with the floating diffusion FD may also include a capacitance component formed with a member other than the ground node.

A drain of the reset transistor M4 is connected to a source of the reset transistor M5. A connection node between the drain of the reset transistor M4 and the source of the reset transistor M5 is a floating diffusion FD2. The floating diffusion FD2 includes a capacitance component (floating diffusion capacitance) and has a function as a charge holding portion. In FIG. 2, this capacitance component is represented by capacitors C2 and C3. An interconnection having the same potential as that of the floating diffusion FD2 is connected to the floating diffusion FD2. A capacitance component formed by an electrostatic coupling between at least a part of the interconnection and the interconnection connected to a gate of the transfer transistor M1 is the capacitor C2. The interconnection connected to the floating diffusion FD2 and the interconnection connected to the gate of the transfer transistor M1 may be arranged in parallel. For example, the capacitor C2 may be configured by a metal-oxide-metal (MOM) capacitor, a metal-insulator-metal (MIM) capacitor, a polysilicon-oxide-metal (POM) capacitor, or the like, or a combination thereof. The capacitor C2 is set to have a capacitance value sufficient to change the potential of the floating diffusion FD due to capacitive coupling with the floating diffusion FD when the transfer transistor M1 is driven. Note that the interconnection connected to the floating diffusion FD2 and the interconnection connected to the gate of the transfer transistor M1 are not necessarily strictly parallel to each other and may be arranged side by side so as to form capacitive coupling therebetween.

The capacitor C3 is a capacitance component formed between the floating diffusion FD2 and a member other than the interconnection connected to the gate of the transfer transistor M1. Although one electrode of the capacitor C3 is connected to the ground node in FIG. 2, the capacitor C3 may include a capacitance component formed between the floating diffusion FD2 and a member other than the interconnection connected to the gate of the transfer transistor M1 and the ground node. The capacitor C3 may also include a capacitance component of a channel portion under a gate of the reset transistor M4 added by turning on the reset transistor M4.

A drain of the reset transistor M5 and a drain of the amplifier transistor M2 are connected to a power supply voltage node (voltage: VDD). A source of the amplifier transistor M2 is connected to a drain of the select transistor M3. A source of the select transistor M3 is connected to the output line 16. The voltage supplied to the drain of the reset transistor M5 and the voltage supplied to the drain of the amplifier transistor M2 may be the same or different.

Each of the control lines 14 includes four signal lines including a signal line connected to a gate of the transfer transistor M1, a signal line connected to the select transistor M3, a signal line connected to the reset transistor M5, and a signal line connected to the reset transistor M4. A control signal P_TX output from the vertical scanning circuit 20 is supplied to the signal line connected to the gate of the transfer transistor M1. A control signal P_SEL output from the vertical scanning circuit 20 is supplied to the signal line connected to the gate of the select transistor M3. The control signal P_RES output from the vertical scanning circuit 20 is supplied to the signal line connected to the gate of the reset transistor M5. The control signal P_RES1 output from the vertical scanning circuit 20 is supplied to the signal line connected to the gate of the reset transistor M4. In the case where each transistor is formed of an n-channel transistor, the corresponding transistor is turned on when a high-level control signal is supplied from the vertical scanning circuit 20, and the corresponding transistor is turned off when a low-level control signal is supplied from the vertical scanning circuit 20.

The present embodiment will be described on the assumption that electrons among electron-hole pairs generated in the photoelectric conversion unit PD by light incidence are used as a signal charge. When electrons are used as the signal charge, each transistor constituting the pixel 12 may be formed of an n-channel MOS transistor. However, the signal charge is not limited to electrons, and holes may be used as the signal charge. When holes are used as the signal charge, the conductivity type of each transistor is opposite to that described in the present embodiment. In this specification, when the first conductivity type is n-type, the second conductivity type is p-type, and when the first conductivity type is p-type, the second conductivity type is n-type. When the charge of the first polarity is a negative charge (electron), the charge of the second polarity is a positive charge (hole), and when the charge of the first polarity is a positive charge (hole), the charge of the second polarity is a negative charge (electron).

The names of the source and the drain of the MOS transistor may vary depending on the conductivity type of the transistor and the function of interest of the transistor. Some or all of the names of the source and the drain used in the present embodiment may be referred to as reverse names. In this specification, the source and the drain of the MOS transistor may be referred to as a main node, and the gate thereof may be referred to as a control node.

The photoelectric conversion unit PD converts (photoelectrically converts) the incident light into charge of an amount corresponding to the amount of the incident light and accumulates the generated charge. The transfer transistor M1 has a function of a transfer unit that transfers the charge held in the photoelectric conversion unit PD to the floating diffusion FD by turning on. The floating diffusion FD holds the charge transferred from the photoelectric conversion unit PD and sets a voltage of an input node of an amplifier unit (the gate of the amplifier transistor M2) to a voltage corresponding to the capacitance thereof (floating diffusion capacitance) and the amount of the transferred charge.

The reset transistor M4 has a function as a switch that electrically connects the floating diffusion FD and the floating diffusion FD2 by turning on. The reset transistor M4 also has a function of switching the capacitance of the floating diffusion FD according to the connection state thereof. That is, the reset transistor M4 is turned on to add the capacitors C2 and C3 to the capacitor C1 of the floating diffusion FD and is turned off to separate the capacitors C2 and C3 from the capacitor C1 of the floating diffusion FD.

The reset transistor M5 has a function as a reset unit that resets the floating diffusions FD and FD2 to a voltage corresponding to the voltage VDD by turning on together with the reset transistor M4. At this time, it is also possible to reset the photoelectric conversion unit PD to a voltage corresponding to the voltage VDD by turning on the transfer transistor M1.

The amplifier transistor M2 has the drain to which the voltage VDD is supplied and the source to which a bias current is supplied from a current source (not illustrated) via the select transistor M3 and constitutes an amplifier unit (source follower circuit) having the gate as an input node. As a result, the amplifier transistor M2 generates a signal corresponding to the voltage of the floating diffusion FD and outputs the signal to the output line 16 via the select transistor M3. That is, the amplifier transistor M2 and the select transistor M3 function as an output unit that outputs a signal according to the potential of the floating diffusion FD.

The select transistor M3 selects whether to output a signal corresponding to the source voltage of the amplifier transistor M2 to the output line 16 as a pixel signal. That is, the select transistor M3 enables the pixel 12 to output the signal to the output line 16 by turning on (selected state).

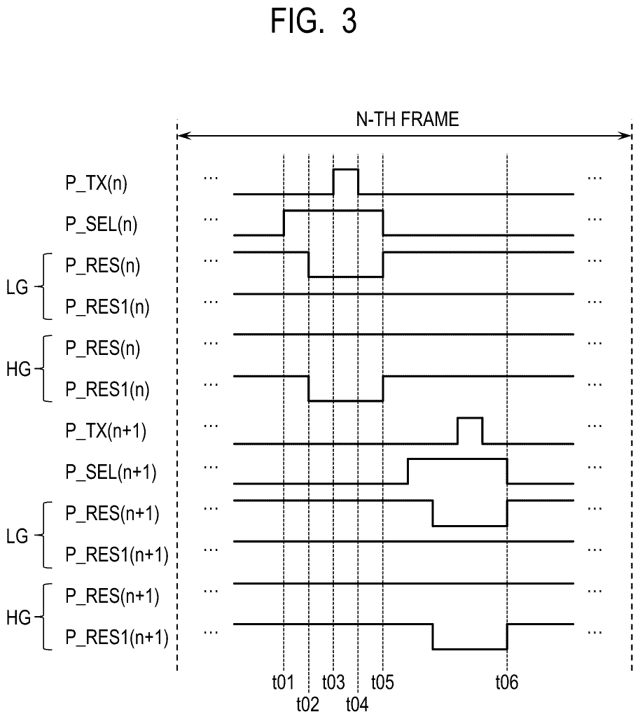

Next, a more specific operation example of the pixel 12 will be described with reference to FIG. 3. FIG. 3 is a timing chart illustrating the operation of the pixel in the photoelectric conversion device according to the present embodiment. FIG. 3 illustrates temporal changes of the control signals P_TX, P_SEL, P_RES, and P_RES1 supplied from the vertical scanning circuit 20 to the pixels 12. When each control signal is at high-level, the corresponding transistor is active (on state).

In a frame period which is a unit period for acquiring one image, a pixel signal readout operation in which a pixel signal based on the signal charge accumulated in the photoelectric conversion unit PD of each pixel 12 during a predetermined exposure period is sequentially read out from the pixel unit 10 row by row is executed. FIG. 3 illustrates the control signals supplied to the pixels 12 in the n-th row and the control signals supplied to the pixels 12 in the (n+1)-th row among the control signals supplied during the N-th frame. Reference sign (n) is appended to the control signals supplied to the pixels 12 in the n-th row, and reference sign (n+1) is appended to the control signals supplied to the pixels 12 in the (n+1)-th row. It is assumed that the readout operation of the n-th row starts at time t01, and the readout operation of the (n+1)-th row ends at time t06.

The photoelectric conversion device according to the present embodiment includes a plurality of operation modes including a high gain mode (hereinafter referred to as an HG mode) and a low gain mode (hereinafter referred to as an LG mode). In the HG mode, the reset transistor M4 is turned off at the time of signal readout to reduce the capacitance of the floating diffusion FD. Accordingly, the signal amplitude of the output with respect to the input of the small signal may be increased, and the noise in the imaging scene with a small amount of light may be suppressed to be small. In the LG mode, the reset transistor M4 is turned on to increase the capacitance added to the floating diffusion FD. This makes it possible to read out a large signal generated in an imaging scene with a large amount of light. The drive pulses of the control signals P_RES and P_RES1 are different between the HG mode and the LG mode. Although FIG. 3 also illustrates the control signals P_RES and P_RES1 in the LG mode and the control signals P_RES and P_RES1 in the HG mode, one of them is supplied according to the operation mode.

It is assumed that, just before the time t01, the control signals P_TX(n), P_SEL(n), P_TX(n+1), and P_SEL(n+1) are at low-level. It is also assumed that the control signals P_RES(n), P_RES1(n), P_RES(n+1), and P_RES1(n+1) are at high-level.

At the time t01, the vertical scanning circuit 20 controls the control signal P_SEL(n) from low-level to high-level. As a result, the select transistor M3 of each of the pixels 12 in the n-th row is turned on, the amplifier transistor M2 of the pixel 12 in each column in the n-th row is connected to the output line 16 in the corresponding column via the select transistor M3, and a selected state in which the pixel signal may be read out is obtained. At this time, the reset transistors M5 and M4 are turned on by receiving the high-level control signals P_RES(n) and P_RES1(n), and the floating diffusions FD and FD2 are reset to a potential corresponding to the voltage VDD. As a result, a signal corresponding to the reset potential of the floating diffusion FD is output to each of the output lines 16.

In the case of the HG mode, the vertical scanning circuit 20 controls the control signal P_RES1(n) from high-level to low-level at the subsequent time t02. As a result, the reset transistor M4 of each of the pixels 12 in the n-th row is turned off, and the reset state of the floating diffusion FD is released. The voltage of the output line 16 that is settled after the reset transistor M4 is turned off is the reset level voltage VRES of the pixel 12. Thus, the reset level voltage VRES of the pixel 12 is read out to the output line 16. Thereafter, the capacitance associated with the floating diffusion FD becomes the capacitor C1, and signal readout with a high gain is performed.

On the other hand, in the case of the LG mode, the vertical scanning circuit 20 controls the control signal P_RES(n) from high-level to low-level at the time t02. As a result, the reset transistor M5 of each of the pixels 12 in the n-th row is turned off, and the reset state of the floating diffusions FD and FD2 is released. The voltage of the output line 16 that is settled after the reset transistor M5 is turned off is the reset level voltage VRES of the pixel 12. Thus, the reset level voltage VRES of the pixel 12 is read out to the output line 16. Thereafter, the capacitance associated with the floating diffusion FD becomes the total capacitance of the capacitors C1, C2, and C3, and signal readout with a low gain is performed.

In the subsequent period from time t03 to time t04, the vertical scanning circuit 20 controls the control signal P_TX(n) from low-level to high-level. As a result, the transfer transistor M1 of each of the pixels 12 in the n-th row is turned on, and the signal charge held in the photoelectric conversion unit PD is transferred to the floating diffusion FD. At this time, the floating diffusion FD has a potential corresponding to the amount of the signal charge transferred from the photoelectric conversion unit PD, and a voltage corresponding to the potential of the floating diffusion FD is output to the output line 16.

At this time, the voltage of the floating diffusion FD in the LG mode increases as the control signal P_TX changes due to capacitive coupling by the capacitor C2 between the signal line transmitting the control signal P_TX and the floating diffusion FD2. Here, when the voltage increase amount of the floating diffusion FD is dV and the voltage difference between the on-voltage and the off-voltage of the control signal P_TX is dVtx, the voltage increase amount dV may be expressed by the following expression (1).

$$d V = d V t x \times C 2 / ( C 1 + C 2 + C 3 ) \qquad ( 1 )$$

The voltage of the floating diffusion FD is increased, whereby a larger amount of charge may be accumulated in the floating diffusion FD, and the dynamic range of the output signal may be expanded. In addition, since the potential difference between the floating diffusion FD and the photoelectric conversion unit PD becomes larger by increasing the voltage of the floating diffusion FD, the charge to be transferred from the photoelectric conversion unit PD to the floating diffusion FD is unlikely to remain in the photoelectric conversion unit PD. This makes it easy to realize complete transfer of the charge from the photoelectric conversion unit PD to the floating diffusion FD.

When the capacitor C2 is large, for example, in a circuit in which the capacitance value of the capacitor C2 is larger than the capacitance value of the capacitor C3, this effect may be further increased. For example, in the case of a pixel circuit in which the capacitor C1 is 1 fF, the capacitor C2 is 2 fF, the capacitor C3 is 1 fF, and the voltage difference dVtx of the control signal P_TX is 4 V, 2 V may be obtained as the voltage increase amount dV.

When the capacitor C2 is small, for example, in a circuit in which the capacitance value of the capacitor C3 is larger than the capacitance value of the capacitor C2, it is possible to reduce the influence of the control signal P_TX on the settling of the voltage of the floating diffusion FD. In this case, even in the case where the settling of the control signal P_TX is slow, since the ratio of the capacitor C2 to the total capacitance of the floating diffusion FD is small, the settling of the voltage of the floating diffusion FD is hardly affected by the settling of the control signal P_TX. This leads to an improvement in frame rate and a decrease in readout noise. For example, in the case of a pixel circuit in which the capacitor C1 is 1 fF, the capacitor C2 is 2 fF, the capacitor C3 is 5 fF, and the voltage difference dVtx of the control signal P_TX is 4 V, the ratio of the capacitor C2 to the total capacitance of the floating diffusion FD may be suppressed to 25% while obtaining 1 V as the voltage increase amount dV.

The voltage of the output line 16 that is settled after the transfer transistor M1 is turned off at time t04 is the signal level voltage VSIG of the pixel 12. Thus, the signal level voltage VSIG of the pixel 12 based on the signal charge held in the photoelectric conversion unit PD is read out to the output line 16. The difference between the reset level voltage VRES and the signal level voltage VSIG obtained in this manner, that is, the potential difference |VSIG-VRES|, becomes a physical quantity corresponding to the amount of the signal charge held in the photoelectric conversion unit PD.

At the subsequent time t05, the vertical scanning circuit 20 controls the control signal PRES1(n) from low-level to high-level in the case of the HG mode and controls the control signal P_RES(n) from low-level to high-level in the case of the LG mode. As a result, the reset transistors M5 and M4 of each of the pixels 12 on the n-th row are both turned on, and the floating diffusions FD and FD2 are reset to a potential corresponding to the voltage VDD. A signal corresponding to the reset potential of the floating diffusion FD is output to the output line 16.

At the time t05, the vertical scanning circuit 20 also controls the control signal P_SEL(n) from high-level to low-level. As a result, the select transistor M3 of the pixel 12 of the n-th row is turned off, and the selection of the n-th row is canceled.

In the period from the subsequent time t05 to the subsequent time t06, similarly to the period from the time t01 to the time t05, the signal based on the signal charge accumulated in the photoelectric conversion unit PD is read out from the pixels 12 of the (n+1)-th row. The same applies to the readout operations of the pixels 12 on the other rows.

As a capacitor to be added to the floating diffusion, a coupling capacitance between an interconnection of a fixed potential and the floating diffusion may be used, but in this case, it is necessary to add an interconnection or a circuit for capacitance adjustment of the floating diffusion, and there is a concern that the number of interconnections, the interconnection density, the number of circuits, and the circuit density increase. For this reason, in particular, in an imaging device having a small pixel size, there is a possibility that the yield of the interconnection and the circuit deteriorates and the manufacturing cost increases.

In this regard, in the photoelectric conversion device according to the present embodiment, since the capacitance of the floating diffusion is controlled by utilizing the capacitance formed by the electrostatic coupling between the interconnection connected to the transfer line and the interconnection connected to the floating diffusion, a dedicated circuit for adjusting the capacitance of the floating diffusion is not necessary. Thus, it is possible to realize a circuit configuration for acquiring an image in a high dynamic range while suppressing an increase in manufacturing cost due to a complicated circuit.

As described above, according to the present embodiment, in the photoelectric conversion device, a circuit configuration for acquiring an image having a high dynamic range may be realized at low cost.

### Second Embodiment

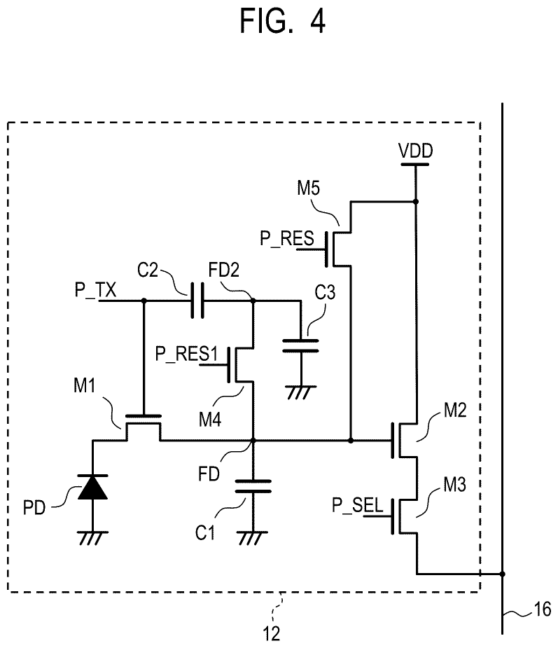

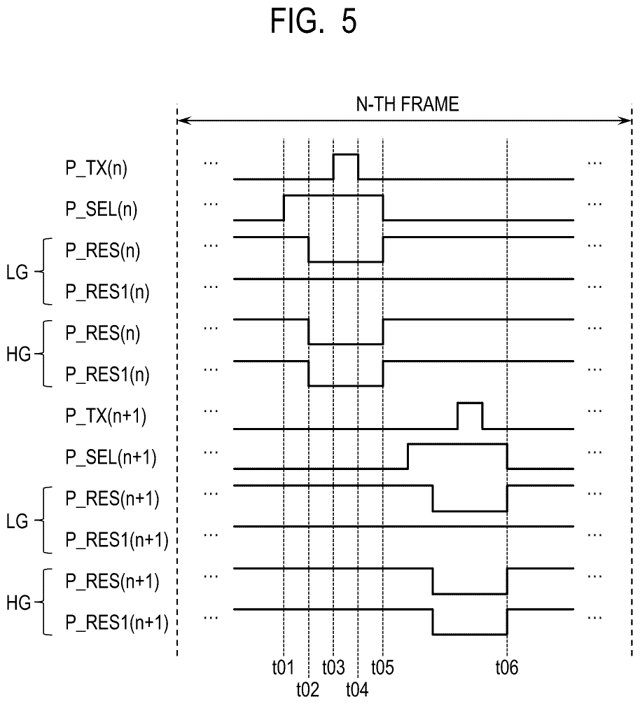

A photoelectric conversion device and a method of driving the same according to a second embodiment will be described with reference to FIG. 4 and FIG. 5. The same components as those of the photoelectric conversion device according to the first embodiment are denoted by the same reference numerals, and description thereof will be omitted or simplified. FIG. 4 is an equivalent circuit diagram illustrating a configuration example of a pixel of the photoelectric conversion device according to the present embodiment. FIG. 5 is a timing chart illustrating the operation of the pixel in the photoelectric conversion device according to the present embodiment.

The photoelectric conversion device according to the present embodiment is the same as the photoelectric conversion device according to the first embodiment except that the configuration of the pixel 12 is different. In the present embodiment, differences from the photoelectric conversion device of the first embodiment will be mainly described, and description of portions similar to those of the photoelectric conversion device of the first embodiment will be appropriately omitted.

As illustrated in FIG. 4, the pixel 12 of the photoelectric conversion device according to the present embodiment is different from the pixel 12 of the photoelectric conversion device according to the first embodiment in that the source of the reset transistor M5 is connected not to the floating diffusion FD2 but to the floating diffusion FD.

In the pixel 12 of the present embodiment, a connection node between the drain of the transfer transistor M1, the source of the reset transistor M4, the source of the reset transistor M5, and the gate of the amplifier transistor M2 is the floating diffusion FD. The floating diffusion FD includes a capacitor C1 (floating diffusion capacitance) and has a function as a charge holding portion. Although one electrode of the capacitor C1 is connected to the ground node in FIG. 4, the capacitance component connected to the floating diffusion FD may include a capacitance component formed with a member other than the ground node.

In the pixel 12 of the present embodiment, the drain of the reset transistor M4 is the floating diffusion FD2. The floating diffusion FD2 includes capacitance components (capacitors C2 and C3) and has a function as a charge holding portion. An interconnection having the same potential as that of the floating diffusion FD2 is connected to the floating diffusion FD2. A capacitance component formed between at least a part of the interconnection and an interconnection connected to the gate of the transfer transistor M1 is a capacitor C2. The capacitor C3 is a capacitance component formed between the floating diffusion FD2 and a member other than the interconnection connected to the gate of the transfer transistor M1. Although one electrode of the capacitor C3 is connected to the ground node in FIG. 4, the capacitor C3 may include a capacitance component formed with a member other than an interconnection connected to the gate of the transfer transistor M1 and the ground node.

Similarly to the first embodiment, the reset transistor M4 is turned on to connect the floating diffusion FD and the floating diffusion FD2. In addition, the reset transistor M4 has a function of switching the capacitance of the floating diffusion FD according to the operation state thereof. That is, the reset transistor M4 is turned on to add the capacitors C2 and C3 to the capacitor C1 of the floating diffusion FD and is turned off to separate the capacitors C2 and C3 from the floating diffusion FD. The reset transistor M5 is turned on to reset the floating diffusion FD to a voltage corresponding to the voltage VDD. At this time, it is also possible to reset the photoelectric conversion unit PD to a voltage corresponding to the voltage VDD by turning on the transfer transistor M1.

Also in the photoelectric conversion device according to the present embodiment, similarly to the photoelectric conversion device according to the first embodiment, a plurality of operation modes including the HG mode and the LG mode may be executed. For example, the method of driving the photoelectric conversion device according to the present embodiment may be the same as the method of driving the photoelectric conversion device according to the first embodiment illustrated in FIG. 3 except for the control signal P_RES in the HG mode. In the HG mode, for example, as illustrated in FIG. 5, the control signal P_RES may be controlled to low-level in a pixel signal readout period (a period from the time t02 to the time t05 in the n-th row).

The photoelectric conversion device of the present embodiment is different from the photoelectric conversion device of the first embodiment in the connection relationship between the source of the reset transistor M5 and the floating diffusions FD and FD2 but may expand the dynamic range of the output signal without adding a drive interconnection or a circuit, as in the first embodiment. The connection between the source of the reset transistor M5 and the floating diffusions FD and FD2 may be appropriately selected in accordance with design constraints of the layout of the pixel 12 or the like.

As described above, according to the present embodiment, in the photoelectric conversion device, a circuit configuration for acquiring an image having a high dynamic range may be realized at low cost.

### Third Embodiment

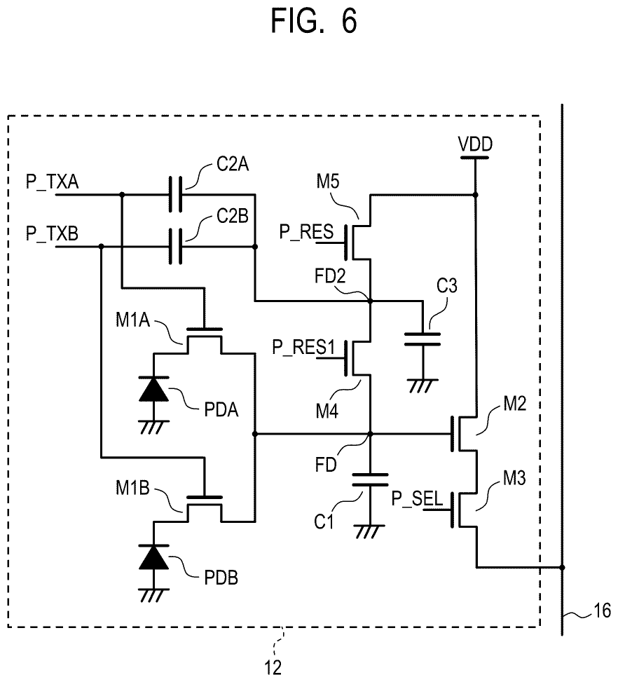

A photoelectric conversion device and a method of driving the same according to a third embodiment will be described with reference to FIG. 6 to FIG. 10. The same components as those of the photoelectric conversion device according to the first or second embodiment are denoted by the same reference numerals, and description thereof will be omitted or simplified.

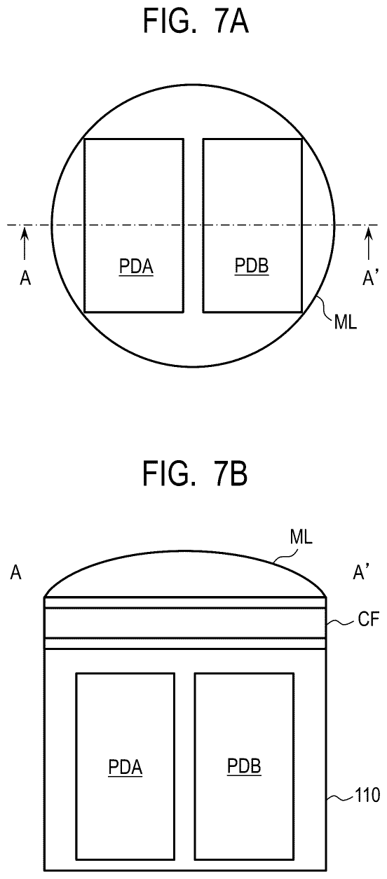

First, a configuration example of the photoelectric conversion device according to the present embodiment will be described with reference to FIG. 6 to FIG. 7B. FIG. 6 is an equivalent circuit diagram illustrating a configuration example of a pixel of the photoelectric conversion device according to the present embodiment. FIG. 7A is a plan view of the pixel of the photoelectric conversion device according to the present embodiment. FIG. 7B is a cross-sectional view of the pixel of the photoelectric conversion device according to the present embodiment.

The photoelectric conversion device according to the present embodiment is the same as the photoelectric conversion device according to the first or second embodiment except that the configuration of the pixel 12 is different. In the present embodiment, differences from the photoelectric conversion device of the first or second embodiment will be mainly described, and description of portions similar to those of the photoelectric conversion device of the first or second embodiment will be appropriately omitted.

As illustrated in FIG. 6, the pixel 12 of the photoelectric conversion device according to the present embodiment may include photoelectric conversion units PDA and PDB, transfer transistors M1A and M1B, an amplifier transistor M2, a select transistor M3, and reset transistors M4 and M5. The photoelectric conversion units PDA and PDB may be configured by photoelectric conversion elements, for example, photodiodes. The transfer transistors M1A and M1B, the amplifier transistor M2, the select transistor M3, and the reset transistors M4 and M5 may be MOS transistors.

The photoelectric conversion unit PDA has an anode connected to the ground node and a cathode connected to a source of the transfer transistor M1A. The photoelectric conversion unit PDB has an anode connected to the ground node and a cathode connected to a source of the transfer transistor M1B. A drain of the transfer transistor M1A and a drain of the transfer transistor M1B are connected to a gate of the amplifier transistor M2 and a source of the reset transistor M4. A connection node between the drain of the transfer transistor M1A, the drain of the transfer transistor M1B, the gate of the amplifier transistor M2, and the source of the reset transistor M4 is a floating diffusion FD. The floating diffusion FD includes a capacitor C1 (floating diffusion capacitance) and has a function as a charge holding portion. Although one electrode of the capacitor C1 is connected to the ground node in FIG. 6, the capacitance component connected to the floating diffusion FD may include a capacitance component formed with a member other than the ground node.

A drain of the reset transistor M4 is connected to a source of the reset transistor M5. A connection node between the drain of the reset transistor M4 and the source of the reset transistor M5 is a floating diffusion FD2. The floating diffusion FD2 includes capacitance components (capacitors C2A, C2B, and C3) and has a function as a charge holding portion. An interconnection having the same potential as that of the floating diffusion FD2 is connected to the floating diffusion FD2. A capacitance component formed between at least a part of the interconnection and an interconnection connected to a gate of the transfer transistor M1A is a capacitor C2A. A capacitance component formed between at least a part of the interconnection and an interconnection connected to a gate of the transfer transistor M1B is the capacitor C2B. The capacitor C3 is a capacitance component formed between the floating diffusion FD2 and a member other than the interconnection connected to the gate of the transfer transistor M1A and the interconnection connected to the gate of the transfer transistor M1B. Although one electrode of the capacitor C3 is connected to the ground node in FIG. 6, the capacitor C3 may include a capacitance component formed with a member other than the interconnection connected to the gates of the transfer transistors M1A and M1B and the ground node. The capacitor C3 may also include a capacitance component of a channel portion under the gate added by turning on the reset transistor M4.

Each of the control lines 14 includes five signal lines connected to gates of the transfer transistor M1A, the transfer transistor M1B, the select transistor M3, the reset transistor M5, and the reset transistor M4. A control signal P_TXA is output from the vertical scanning circuit 20 to the signal line connected to the gate of the transfer transistor M1A. A control signal P_TXB is output from the vertical scanning circuit 20 to the signal line connected to the gate of the transfer transistor M1B. A control signal P_SEL is output from the vertical scanning circuit 20 to the signal line connected to the gate of the select transistor M3. A control signal P_RES is output from the vertical scanning circuit 20 to the signal line connected to the gate of the reset transistor M5. A control signal P_RES1 is output from the vertical scanning circuit 20 to the signal line connected to the gate of the reset transistor M4. In the case where each transistor is formed of an n-channel transistor, the corresponding transistor is turned on when a high-level control signal is supplied from the vertical scanning circuit 20, and the corresponding transistor is turned off when a low-level control signal is supplied from the vertical scanning circuit 20.

FIG. 7A and FIG. 7B are schematic diagrams illustrating an arrangement example of the photoelectric conversion unit PDA and the photoelectric conversion unit PDB configuring one pixel 12. FIG. 7A is a top view, and FIG. 7B is a cross-sectional view taken along line A-A′ of FIG. 7A. The photoelectric conversion unit PDA and the photoelectric conversion unit PDB are provided in the semiconductor layer 110 together with each transistor (not illustrated) configuring the pixel 12. A microlens ML is disposed above the semiconductor layer 110 with a color filter layer CF and the like interposed therebetween. As illustrated in FIG. 7A and FIG. 7B, the photoelectric conversion unit PDA and the photoelectric conversion unit PDB configuring one pixel 12 share one microlens ML. In other words, the photoelectric conversion unit PDA and the photoelectric conversion unit PDB are configured to receive light that has passed through different pupil regions among light incident on the imaging optical system. That is, the microlens ML condenses the light that has passed through the first pupil region of the exit pupil of the imaging lens on the photoelectric conversion unit PDA and condenses the light that has passed through the second pupil region different from the first pupil region on the photoelectric conversion unit PDB. With this configuration, the signal (A image signal) based on the charge generated by the photoelectric conversion unit PDA and the signal (B image signal) based on the charge generated by the photoelectric conversion unit PDB may be used as a phase difference detection signal for distance measurement. The signal (A+B image signal) based on the total charge generated by the photoelectric conversion units PDA and PDB may be used as a signal for image generation.

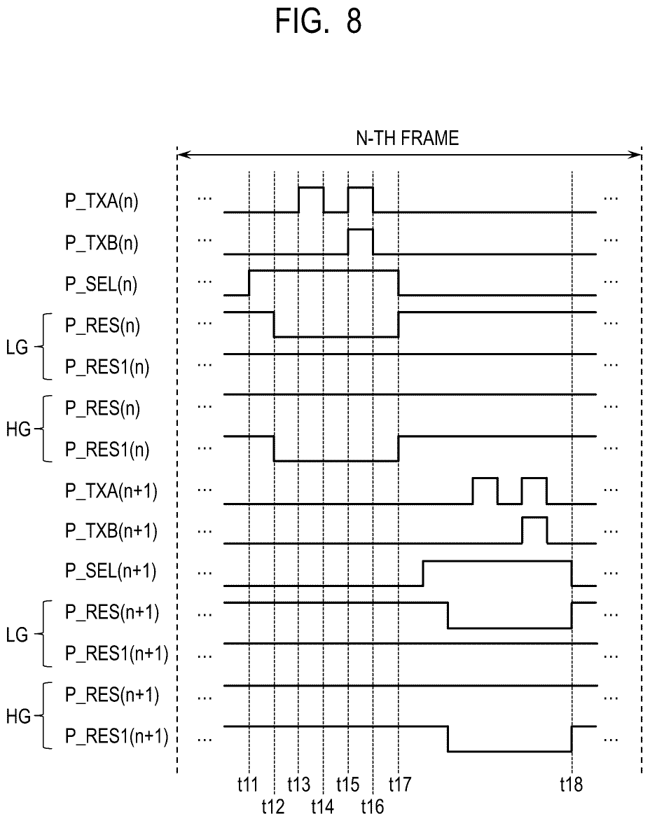

Next, a more specific operation example of the pixel 12 will be described with reference to FIG. 8. FIG. 8 is a timing chart illustrating the operation of a pixel in the photoelectric conversion device according to the present embodiment. FIG. 8 illustrates temporal changes of the control signals P_TXA, P_TXB, P_SEL, P_RES, and P_RES1 supplied from the vertical scanning circuit 20 to the pixels 12. When each control signal is at high-level, the corresponding transistor is active (on state).

In a frame period which is a unit period for acquiring one image, a pixel signal readout operation in which a pixel signal based on the signal charge accumulated in the photoelectric conversion unit PD of each pixel 12 during a predetermined exposure period is sequentially read out from the pixel unit 10 row by row is executed. FIG. 8 illustrates the control signals supplied to the pixels 12 in the n-th row and the control signals supplied to the pixels 12 in the (n+1)-th row among the control signals supplied during the N-th frame. Reference sign (n) is appended to the control signals supplied to the pixels 12 in the n-th row, and reference sign (n+1) is appended to the control signals supplied to the pixels 12 in the (n+1)-th row. It is assumed that the readout operation of the n-th row starts at time t11, and the readout operation of the (n+1)-th row ends at time t18.

Also in the photoelectric conversion device according to the present embodiment, as described above, a plurality of operation modes including the HG mode and the LG mode may be executed. In the HG mode, the reset transistor M4 is turned off at the time of signal readout to reduce the capacitance of the floating diffusion FD. Accordingly, the signal amplitude of the output with respect to the input of the small signal may be increased, and the noise in the imaging scene with a small amount of light may be suppressed to be small. In the LG mode, the reset transistor M4 is turned on to increase the capacitance added to the floating diffusion FD. This makes it possible to read out a large signal generated in an imaging scene with a large amount of light. The drive pulses of the control signals P_RES and P_RES1 are different between the HG mode and the LG mode. Although FIG. 8 also illustrates the control signals P_RES and P_RES1 in the LG mode and the control signals P_RES and P_RES1 in the HG mode, one of them is supplied according to the operation mode.

It is assumed that, just before the time t11, the control signals P_TXA(n), P_TXB(n), and P_SEL(n) are at low-level, and the control signals P_RES(n) and P_RES1(n) are at high-level. It is also assumed that the control signals P_TXA(n+1), P_TXB(n+1), and P_SEL(n+1) are at low-level, and the control signals P_RES(n+1) and P_RES1(n+1) are at high-level.

At the time t11, the vertical scanning circuit 20 controls the control signal P_SEL(n) from low-level to high-level. As a result, the select transistor M3 of each of the pixels 12 in the n-th row is turned on, the amplifier transistor M2 of the pixel 12 in each column in the n-th row is connected to the output line 16 in the corresponding column via the select transistor M3, and a selection state in which the pixel signal may be read out is obtained. At this time, the reset transistors M5 and M4 are turned on by receiving the high-level control signals P_RES(n) and P_RES1(n), and the floating diffusions FD and FD2 are reset to a potential corresponding to the voltage VDD. As a result, a signal corresponding to the reset potential of the floating diffusion FD is output to the output line 16.

In the case of the HG mode, the vertical scanning circuit 20 controls the control signal P_RES1(n) from high-level to low-level at the subsequent time t12. As a result, the reset transistor M4 of each of the pixels 12 in the n-th row is turned off, and the reset state of the floating diffusion FD is released. The voltage of the output line 16 that is settled after the reset transistor M4 is turned off is the reset level voltage VRES of the pixel 12. Thus, the reset level voltage VRES of the pixel 12 is read out to the output line 16. Thereafter, the capacitance associated with the floating diffusion FD becomes the capacitor C1, and signal readout with a high gain is performed.

On the other hand, in the case of the LG mode, the vertical scanning circuit 20 controls the control signal P_RES(n) from high-level to low-level at the time t12. As a result, the reset transistor M5 of each of the pixels 12 in the n-th row is turned off, and the reset state of the floating diffusions FD and FD2 is released. The voltage of the output line 16 that is settled after the reset transistor M5 is turned off is the reset level voltage VRES of the pixel 12. Thus, the reset level voltage VRES of the pixel 12 is read out to the output line 16. Thereafter, the capacitance associated with the floating diffusion FD becomes the total capacitance of the capacitors C1, C2, and C3, and signal readout with a low gain is performed.

In the subsequent period from time t13 to time t14, the vertical scanning circuit 20 controls the control signal P_TXA(n) from low-level to high-level. As a result, the transfer transistor M1A of each of the pixel 12 in the n-th row is turned on, and the signal charge held in the photoelectric conversion unit PDA is transferred to the floating diffusion FD. At this time, the floating diffusion FD has a potential corresponding to the amount of the signal charge transferred from the photoelectric conversion unit PDA, and a voltage corresponding to the potential of the floating diffusion FD is output to the output line 16.

At this time, the voltage of the floating diffusion FD in the LG mode increases as the control signal P_TXA changes due to capacitive coupling by the capacitor C2A between the signal line transmitting the control signal P_TXA and the floating diffusion FD2. Here, when the voltage increase amount of the floating diffusion FD is dV and the voltage difference between the on-voltage and the off-voltage of the control signal P_TXA is dVtx, the voltage increase amount dV may be expressed by the following equation (2).

$$d V = d V t x \times C 2 A / ( C 1 + C 2 A + C 2 B + C 3 ) \qquad ( 2 )$$

The voltage of the floating diffusion FD is increased, whereby a larger amount of charge may be accumulated in the floating diffusion FD, and the dynamic range of the output signal may be expanded. In addition, since the potential difference between the floating diffusion FD and the photoelectric conversion unit PDA becomes larger by increasing the voltage of the floating diffusion FD, the charge to be transferred from the photoelectric conversion unit PDA to the floating diffusion FD is unlikely to remain in the photoelectric conversion unit PDA. This makes it easy to realize complete transfer of charge from the photoelectric conversion unit PDA to the floating diffusion FD.

The capacitance associated with the signal line transmitting the control signal P_TXA at the time of reading out the A image signal is smaller than the capacitance associated with the signal line transmitting the control signals P_TXA and P_TXB at the time of reading out the A+B image signal. Therefore, it is possible to shorten the length of the period in which the transfer transistor M1A is turned on (the period from the time t13 to the time t14), thereby improving the frame rate.

The voltage of the output line 16 that is settled after the transfer transistor M1A is turned off at the time t14 is the signal level voltage VSIGA of the pixel 12. Thus, the signal level voltage VSIGA of the pixel 12 based on the signal charge held in the photoelectric conversion unit PDA is read out to the output line 16. The difference between the reset level voltage VRES and the signal level voltage VSIGA obtained in this manner, i.e., the difference of |VSIGA-VRES|, becomes a physical quantity corresponding to the amount of the signal charge held in the photoelectric conversion unit PDA.

In the subsequent period from time t15 to time t16, the vertical scanning circuit 20 controls the control signals P_TXA(n) and P_TXB(n) from low-level to high-level. As a result, the transfer transistors M1A and M1B of each of the pixels 12 on the n-th row are turned on, and the signal charge held in the photoelectric conversion units PDA and PDB are transferred to the floating diffusion FD. At this time, the floating diffusion FD has a potential corresponding to the amount of signal charge transferred from the photoelectric conversion units PDA and PDB, and a voltage corresponding to the potential of the floating diffusion FD is output to the output line 16.

At this time, the voltage of the floating diffusion FD in the case of the LG mode increases as the control signals P_TXA and P_TXB change due to capacitive coupling by the capacitors C2A and C2B between the floating diffusion FD2 and the signal lines transmitting the control signals P_TXA and P_TXB. Here, when the voltage increase amount of the floating diffusion FD is dV, the voltage difference between the on-voltage and the off-voltage of the control signal P_TXA is dVtxA, and the voltage difference between the on-voltage and the off-voltage of the control signal P_TXB is dVtxB, the voltage increase amount dV may be expressed by the following equation (3).

$$d V = ( d V t x A \times C 2 A + d V t x B \times C 2 B ) / ( C 1 + C 2 A + C 2 B + C 3 ) \qquad ( 3 )$$

The voltage of the floating diffusion FD is increased, whereby a larger amount of charge may be accumulated in the floating diffusion FD, and the dynamic range of the output signal may be expanded. In addition, since the potential difference between the floating diffusion FD and the photoelectric conversion units PDA and PDB becomes larger by increasing the voltage of the floating diffusion FD, the charges to be transferred from the photoelectric conversion units PDA and PDB to the floating diffusion FD are unlikely to remain in the photoelectric conversion units PDA and PDB. This makes it easy to realize complete transfer of charges from the photoelectric conversion units PDA and PDB to the floating diffusion FD.

When the capacitor C2A and the capacitor C2B are large, for example, in a circuit in which the sum of the capacitance value of the capacitor C2A and the capacitance value of the capacitor C2B is larger than the capacitance value of the capacitor C3, this effect may be further increased. For example, in the case of a pixel circuit in which the capacitor C1 is 1 fF, the capacitor C2A is 1 fF, the capacitor C2B is 1 fF, the capacitor C3 is 1 fF, the voltage difference dVtxA of the control signal P_TXA is 4 V, and the voltage difference dVtxB of the control signal P_TXB is 4 V, 2 V may be obtained as the voltage increase amount dV.

When the capacitor C2A and the capacitor C2B are small, for example, in a circuit in which the sum of the capacitance value of the capacitor C2A and the capacitance value of the capacitor C2B is smaller than the capacitance value of the capacitor C3, it is possible to reduce the influence of the control signal P_TXA or the control signal P_TXB on the settling of the voltage of the floating diffusion FD. In this case, even in a case where the settling of the control signal P_TXA or the control signal P_TXB is slow, since the ratio of the capacitors C2A and C2B to the total capacitance of the floating diffusion FD is small, the settling of the voltage of the floating diffusion FD is hardly affected by the settling of the control signal P_TXA or the control signal P_TXB. This leads to an improvement in frame rate and a decrease in readout noise. For example, in the case of a pixel circuit in which the capacitor C1 is 1 fF, the capacitor C2A is 1 fF, the capacitor C2B is 1 fF, the capacitor C3 is 5 fF, the voltage difference dVtxA of the control signal P_TXA is 4 V, and the voltage difference dVtxB of the control signal P_TXB is 4 V. In this case, while obtaining 1V as the voltage increase amount dV, the ratio of the capacitor C2A to the total capacitance of the floating diffusion FD may be suppressed to about 13%, and the ratio of the capacitor C2B to the total capacitance of the floating diffusion FD may be suppressed to about 13%.

The voltage of the output line 16 that is settled after the transfer transistors M1A and M1B are turned off at the time t16 is the signal level voltage VSIGAB of the pixel 12. Thus, the signal level voltage VSIGAB of the pixel 12 based on the signal charge held in the photoelectric conversion units PDA and PDB is read out to the output line 16. The difference between the reset level voltage VRES and the signal level voltage VSIGAB obtained in this manner, that is, the difference |VSIGAB-VRESB| becomes a physical quantity corresponding to the amount of the signal charge held in the photoelectric conversion units PDA and PDB.

At the subsequent time t17, the vertical scanning circuit 20 controls the control signal PRES1(n) from low-level to high-level in the case of the HG mode and controls the control signal P_RES(n) from low-level to high-level in the case of the LG mode. As a result, the reset transistors M5 and M4 of each of the pixels 12 on the n-th row are both turned on, and the floating diffusions FD and FD2 are reset to a potential corresponding to the voltage VDD. A signal corresponding to the reset potential of the floating diffusion FD is output to the output line 16.

At the time t17, the vertical scanning circuit 20 also controls the control signal P_SEL(n) from high-level to low-level. As a result, the select transistor M3 of each of the pixels 12 of the n-th row is turned off, and the selection of the n-th row is canceled.

In the period from the subsequent time t17 to the subsequent time t18, similarly to the period from the time t11 to the time t17, the signals based on the signal charge accumulated in the photoelectric conversion units PDA, PDB are read out from each of the pixels 12 on the (n+1)-th row. The same applies to the readout operations of the pixels 12 on the other rows.

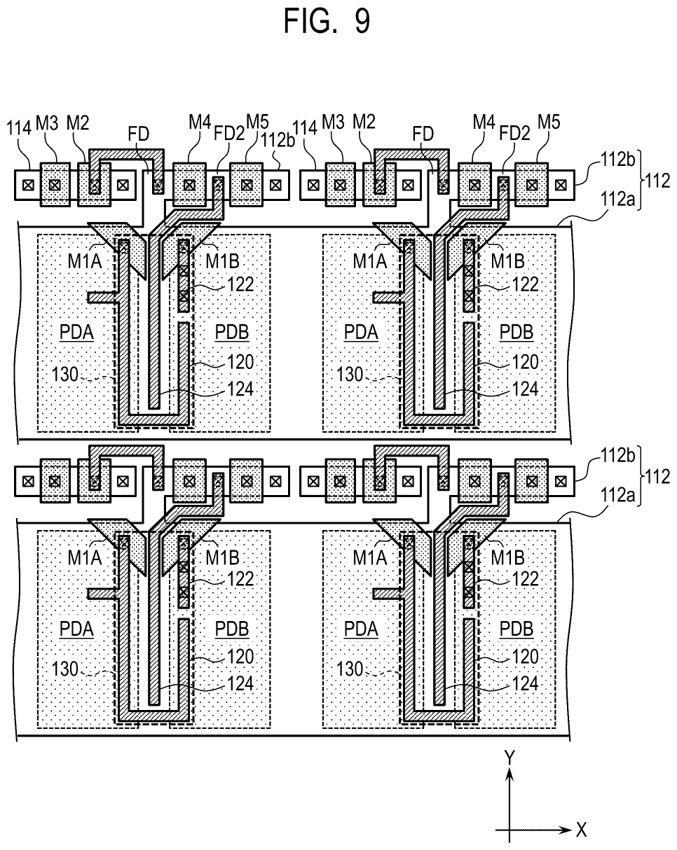

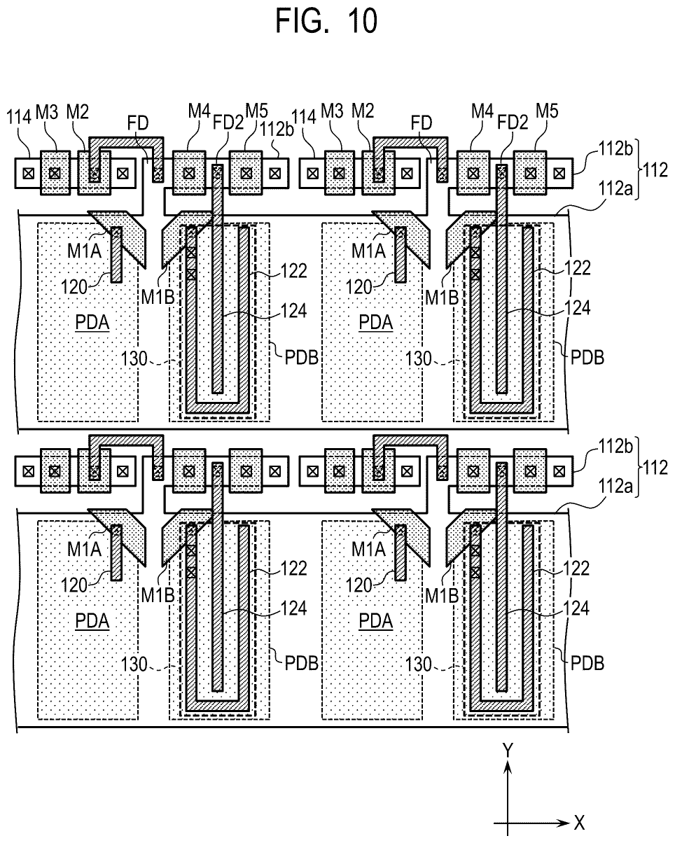

FIG. 9 and FIG. 10 are plan views illustrating layout examples of the pixels 12 in the photoelectric conversion device according to the present embodiment. FIG. 9 and FIG. 10 illustrate four pixels 12 arranged in translational symmetry with respect to the horizontal direction (X-direction) and the vertical direction (Y-direction). For simplification of the drawings, FIG. 9 and FIG. 10 only illustrate patterns of active regions 112 and 114 provided in a semiconductor substrate (semiconductor layer 110), a polycrystalline silicon layer constituting a gate electrode of each transistor, a first interconnection layer, and a second interconnection layer. The active regions 112 and 114 are represented by white regions surrounded by a solid line, and the cathode portions of the photoelectric conversion units PDA and PDB arranged in the active region 112 are represented by regions of a coarse dot pattern surrounded by a broken line. The polycrystalline silicon layer is represented by a region of a fine dot pattern surrounded by a solid line, and the gate electrode of each transistor is denoted by a reference numeral representing the transistor. The first interconnection layer is represented by a hatched region surrounded by a solid line. The second interconnection layer is represented by a white region surrounded by a broken line. Further, a rectangular region marked with a cross mark represents a contact hole or a via-hole between layers for connecting the conductive members. The first interconnection layer and the second interconnection layer may be formed of a metal material such as aluminum or copper.

The active region 112 includes an active region 112a in which the photoelectric conversion units PDA and PDB and the transfer transistors M1A and M1B are arranged, and an active region 112b in which the reset transistors M4 and M5 are arranged. The active region 112a extends in the horizontal direction and forms one region common to the plurality of pixels 12 arranged in the horizontal direction. The active region 112b is provided for each pixel 12 so as to branch from the active region 112a. The active region 114 is a region in which the amplifier transistor M2 and the select transistor M3 are arranged and is provided for each pixel 12 so as to be separated from the active region 112.

The first interconnection layer is arranged above the semiconductor layer 110 and the gate layer with an interlayer insulating film (not illustrated) interposed therebetween, and includes interconnections 120, 122, and 124. The interconnection 120 is electrically connected to the gate of the transfer transistor M1A via a via-hole provided in the interlayer insulating film. The interconnection 122 is electrically connected to the gate of the transfer transistor M1B via a via-hole provided in the interlayer insulating film. The interconnection 124 is electrically connected to the floating diffusion FD2 via a contact hole provided in the interlayer insulating film. The second interconnection layer is arranged above the interconnections 120, 122, and 124 with an interlayer insulating film (not illustrated) interposed therebetween, and includes an interconnection 130. The interconnection 130 is electrically connected to the gate of the transfer transistor M1B via the via-holes provided in the interlayer insulating film and the interconnection 122. In FIG. 9 and FIG. 10, the layouts of the interconnections constituting the first interconnection layer and the second interconnection layer are different from each other.

The control signal P_TXA from the vertical scanning circuit 20 is supplied to each pixel 12 via an interconnection (not illustrated) and is supplied to the gate of the transfer transistor M1A via the interconnection 120. The control signal P_TXB from the vertical scanning circuit 20 is supplied to each pixel 12 via an interconnection (not illustrated) and is supplied to the gate of the transfer transistor M1B via the interconnection 130 and the interconnection 122.

In the layout example of FIG. 9, the interconnection 124 extends in a region between the photoelectric conversion unit PDA and the photoelectric conversion unit PDB. The interconnections 120 and 122 are arranged in parallel to the interconnection 124. By configuring the first interconnection layer and the second interconnection layer in this manner, an MIM-type capacitor constituting the capacitor C2A is formed between the interconnection 124 and the interconnection 120. An MIM-type capacitor constituting the capacitor C2B is formed between the interconnection 124, and the interconnections 122 and 130. The length of the portion where the interconnection 120 and the interconnection 124 are parallelly arranged and the length of the portion where the interconnection 122 and the interconnection 124 are parallelly arranged may be appropriately set in accordance with capacitance values required for the capacitors C2A and C2B. The size of the capacitor C2A and the size of the capacitor C2B may be the same or different.

When the capacitance value of the capacitor C2A is larger than the capacitance value of the capacitor C2B, the voltage increase amount dV of the floating diffusion FD during a period from the time t13 to the time t14 at which the control signal P_TXA is active may be made larger than when the capacitance value of the capacitor C2B is larger than the capacitance value of the capacitor C2A. Since the potential difference between the floating diffusion FD and the photoelectric conversion unit PDA becomes larger by increasing the voltage of the floating diffusion FD, it becomes easy to realize the complete transfer of the charge from the photoelectric conversion unit PDA to the floating diffusion FD, and the voltage VSIGA based on the signal charge held in the photoelectric conversion unit PDA may be more accurately obtained in some cases.

On the other hand, when the capacitance value of the capacitor C2B is larger than the capacitance value of the capacitor C2A, the capacitance associated with the signal line that transmits the control signal P_TXA becomes smaller when the A image signal is read out. Therefore, the length of the period in which the transfer transistor M1A is turned on (from the time t13 to the time t14) may be made shorter, and accordingly, it is possible to have a configuration in which improvement of the frame rate is prioritized.

Note that in the layout example of FIG. 9, the interconnection 130 is provided over the interconnection 120, so that the interconnection 120 and the interconnection 130 are capacitively coupled to each other. In other words, the interconnection 120 and the interconnection 122 are electrostatically coupled to each other via a capacitor. Therefore, the capacitance associated with the gate of the transfer transistor M1A and the capacitance associated with the gate of the transfer transistor M1B may be equalized. Note that another interconnection which is not connected to these interconnections may be provided between the interconnection 120 and the interconnection 122. In this case, the capacitance associated with the gate of the transfer transistor M1A and the capacitance associated with the gate of the transfer transistor M1B are not aligned, and one capacitance is large, and the other capacitance is small.

In the case of having the capacitors C2A and C2B, the potential of the floating diffusion FD increases in the charge transfer period from the photoelectric conversion unit PDA to the floating diffusion FD from the time t13 to the time t14, and in the charge transfer period from the photoelectric conversion units PDA and PDB to the floating diffusion FD from the time t15 to the time t16. Since the potential of the floating diffusion FD is increased at either charge transfer timing, charge transfer from the photoelectric conversion units PDA and PDB to the floating diffusion FD may be facilitated.

In the layout example of FIG. 10, the interconnection 124 extends in a region overlapping the photoelectric conversion unit PDB. The interconnection 122 is arranged in parallel with the interconnection 124. By configuring the first interconnection layer and the second interconnection layer in this manner, an MIM-type capacitor configuring the capacitor C2B is formed between the interconnection 124, and the interconnection 122 and the interconnection 130. In the layout example of FIG. 10, unlike the layout example of FIG. 9, the capacitor C2A is not formed. The length of the portion where the interconnection 122 and the interconnection 124 parallelly arranged may be set as appropriate in accordance with the capacitance value required for the capacitor C2B.

Since the capacitor C2A is not formed in the layout example of FIG. 10, the settling time of the control signal P_TXA in the charge transfer period from the photoelectric conversion unit PDA to the floating diffusion FD from the time t13 to the time t14 becomes shorter than that in the layout example of FIG. 9. Thus, the time required for reading out the signal may be reduced. On the other hand, in the charge transfer period from the photoelectric conversion units PDA and PDB to the floating diffusion FD from the time t15 to the time t16, since the potential of the floating diffusion FD is increased due to the presence of the capacitor C2B, the same effect as in the case of the layout example of FIG. 9 may be obtained.

As described above, according to the present embodiment, in the photoelectric conversion device, a circuit configuration for acquiring an image having a high dynamic range may be realized at low cost.

### Fourth Embodiment

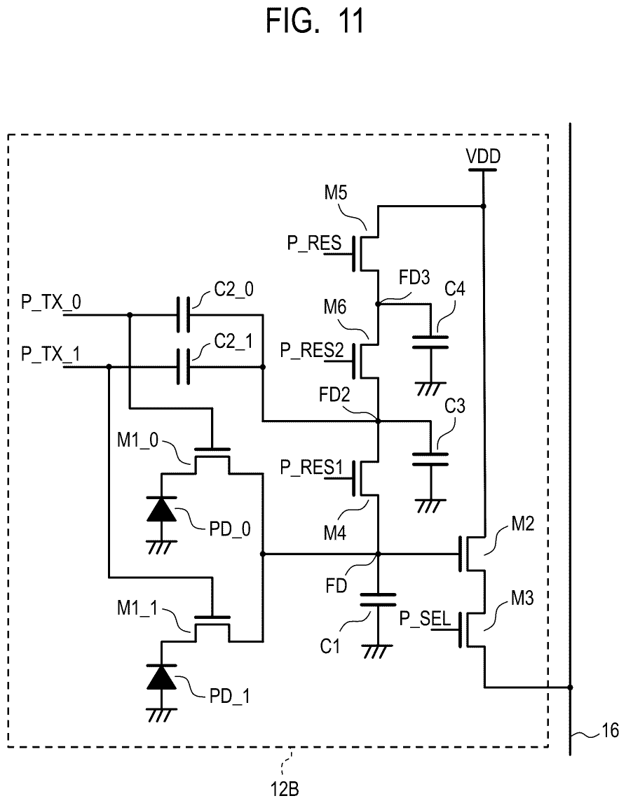

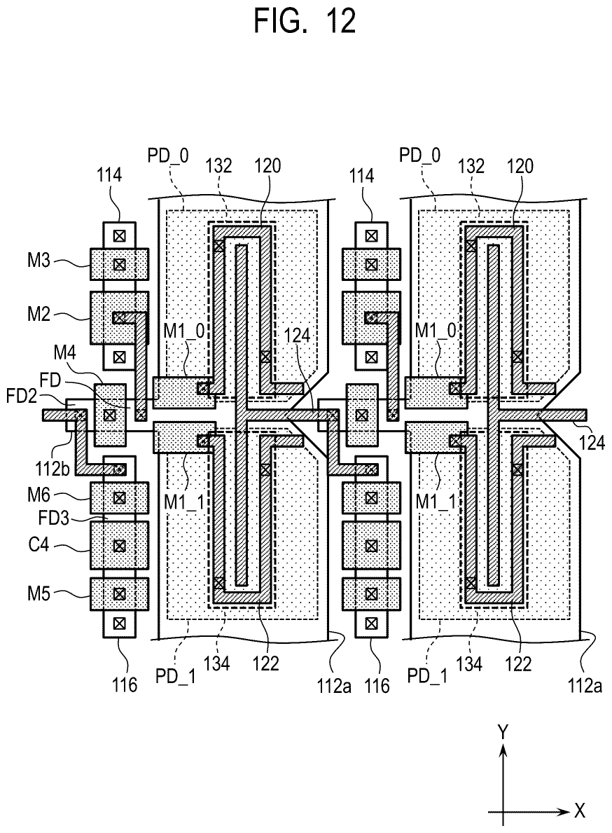

A photoelectric conversion device and a method of driving the same according to a fourth embodiment will be described with reference to FIG. 11 and FIG. 12. The same components as those of the photoelectric conversion devices according to the first to third embodiments are denoted by the same reference numerals, and description thereof will be omitted or simplified. FIG. 11 is an equivalent circuit diagram illustrating a configuration example of a pixel of the photoelectric conversion device according to the present embodiment. FIG. 12 is a plan view illustrating a layout example of pixels in the photoelectric conversion device according to the present embodiment.

The photoelectric conversion device according to the present embodiment is different from the photoelectric conversion devices according to the first to third embodiments in that a readout circuit unit in a pixel is shared by a plurality of pixels 12 and a reset transistor M6 is further provided. In the present embodiment, differences from the photoelectric conversion device of the first embodiment will be mainly described, and description of portions similar to those of the photoelectric conversion device of the first embodiment will be appropriately omitted.

As illustrated in FIG. 11, the photoelectric conversion device according to the present embodiment includes a pixel block 12B including a pixel element including a photoelectric conversion unit PD_0 and a transfer transistor M1_0 and a pixel element including a photoelectric conversion unit PD_1 and a transfer transistor M1_1. The pixel element including the photoelectric conversion unit PD_0 and the transfer transistor M1_0 and the pixel element including the photoelectric conversion unit PD_1 and the transfer transistor M1_1 are arranged in adjacent rows. For example, the pixel element including the photoelectric conversion unit PD_0 and the transfer transistor M1_0 is arranged on the (2n-1)-th row, and the pixel element including the photoelectric conversion unit PD_1 and the transfer transistor M1_1 is arranged in the 2n-th row. Here, n is an integer of 1 or more. The pixel element including the photoelectric conversion unit PD_0 and the transfer transistor M1_0 and the pixel element including the photoelectric conversion unit PD_1 and the transfer transistor M1_0 are typically arranged in the same column but may not necessarily be arranged in the same column and may be arranged in adjacent columns. These two pixel elements share an amplifier transistor M2, a select transistor M3, reset transistors M4, M5, and M6, and floating diffusions FD, FD2, and FD3. One pixel block 12B may correspond to two pixels 12 adjacent to each other in the column direction in the pixel array of FIG. 1.

The photoelectric conversion unit PD_0 has an anode connected to the ground node and a cathode connected to a source of the transfer transistor M1_0. The photoelectric conversion unit PD_1 has an anode connected to the ground node and a cathode connected to a source of the transfer transistor M1_1. A drain of the transfer transistor M1_0 and a drain of the transfer transistor M1_1 are connected to a gate of the amplifier transistor M2 and a source of the reset transistor M4. A connection node between the drain of the transfer transistor M1_0, the drain of the transfer transistor M1_1, the gate of the amplifier transistor M2, and the source of the reset transistor M4 is a floating diffusion FD. The floating diffusion FD includes a capacitance component (floating diffusion capacitance) and has a function as a charge holding portion. In FIG. 11, this capacitance component is represented by a capacitor C1. Although one electrode of the capacitor C1 is connected to the ground node in FIG. 11, the capacitance component associated with the floating diffusion FD may also include a capacitance component formed with a member other than the ground node.

A drain of the reset transistor M4 is connected to a source of the reset transistor M6. A connection node between the drain of the reset transistor M4 and the source of the reset transistor M6 is the floating diffusion FD2. The floating diffusion FD2 includes a capacitance component (floating diffusion capacitance) and has a function as a charge holding portion. In FIG. 11, this capacitance component is represented by capacitors C2_0, C2_1, and C3. An interconnection having the same potential as that of the floating diffusion FD2 is connected to the floating diffusion FD2. A capacitance component formed between at least a part of the interconnection and an interconnection connected to a gate of the transfer transistor M1_0 is a capacitor C2_0. A capacitance component formed between at least a part of the interconnection and an interconnection connected to a gate of the transfer transistor M1_1 is the capacitor C2_1. The interconnection connected to the floating diffusion FD2 and the interconnections connected to the gates of the transfer transistors M1_0 and M1_1 may be disposed in parallel. The capacitor C3 is a capacitance component formed between the floating diffusion FD2 and a member other than the interconnection connected to the gate of the transfer transistor M1_0 and the interconnection connected to the gate of the transfer transistor M1_1. Although one electrode of the capacitor C3 is connected to the ground node in FIG. 11, the capacitor C3 may include a capacitance component formed with a member other than the interconnection connected to the gates of the transfer transistors M1_0 and M1_1 and the ground node. The capacitor C3 may also include a capacitance component of a channel portion under the gate added by turning on the reset transistor M4.

A drain of the reset transistor M6 is connected to a source of the reset transistor M5. A connection node between the drain of the reset transistor M6 and the source of the reset transistor M5 is the floating diffusion FD3. The floating diffusion FD3 includes a capacitance component (capacitor C4) and has a function as a charge holding portion. Although one electrode of the capacitor C4 is connected to the ground node in FIG. 11, the capacitor C4 may include a capacitance component formed with a member other than the ground node. The capacitor C4 may also include a capacitance component of a channel portion under the gate added by turning on the reset transistor M6.

The control line 14 includes six signal lines connected to the gates of the transfer transistor M1_0, the transfer transistor M1_1, the select transistor M3, the reset transistor M5, the reset transistor M6, and the reset transistor M4 for each of two adjacent rows. A control signal P_TX_0 is output from the vertical scanning circuit 20 to the signal line connected to a gate of the transfer transistor M1_0. A control signal P_TX_1 is output from the vertical scanning circuit 20 to the signal line connected to a gate of the transfer transistor M1_1. A control signal P_SEL is output from the vertical scanning circuit 20 to the signal line connected to a gate of the select transistor M3. A control signal P_RES is output from the vertical scanning circuit 20 to the signal line connected to a gate of the reset transistor M5. A control signal P_RES2 is output from the vertical scanning circuit 20 to the signal line connected to a gate of the reset transistor M6. A control signal P_RES1 is output from the vertical scanning circuit 20 to the signal line connected to a gate of the reset transistor M4. In the case where each transistor is formed of an n-channel transistor, the corresponding transistor is turned on when a high-level control signal is supplied from the vertical scanning circuit 20, and the corresponding transistor is turned off when a low-level control signal is supplied from the vertical scanning circuit 20.

The photoelectric conversion device according to the present embodiment may perform a plurality of operation modes including the HG mode, a middle gain mode (hereinafter, referred to as an MG mode), and the LG mode. In the HG mode, the reset transistor M4 is turned off at the time of signal reading out to reduce the capacitance of the floating diffusion FD. Accordingly, the signal amplitude of the output with respect to the input of the small signal may be increased, and the noise in the imaging scene with a small amount of light may be suppressed to be small. In the LG mode, by turning on the reset transistors M4 and M6, the capacitors C2_0, C2_1, C3, and C4 are further added to the capacitor C1 of the floating diffusion FD to increase the capacitance of the floating diffusion FD. This makes it possible to read out a large signal generated in an imaging scene with a large amount of light. In the MG mode, by turning on the reset transistor M4 and turning off the reset transistor M6, the capacitors C2_0 and C2_1 are added to the capacitor C1 of the floating diffusion FD, and the capacitance of the floating diffusion FD is increased. As a result, it is possible to read out a signal generated in an imaging scene having an intermediate light quantity between the HG mode and the LG mode. Since the capacitance of the floating diffusion FD is smaller in the MG mode than in the LG mode, it is possible to capture an image of a scene having a light amount that is saturated in the HG mode with a noise smaller than that in the LG mode by the MG mode. Since the pixel block 12B includes the plurality of reset transistors M4, M5, and M6, it is possible to select a more appropriate capacitance of the floating diffusion FD according to the imaging scene.

In the photoelectric conversion device according to the present embodiment, the interconnection connected to the gate of the transfer transistor M1_0 and the floating diffusion FD2 are capacitively coupled by the capacitor C2_0. The interconnection connected to the gate of the transfer transistor M1_1 and the floating diffusion FD2 are capacitively coupled by the capacitor C2_1. In the LG mode and the MG mode, since the capacitors C2_0 and C2_1 are added to the capacitor C1 of the floating diffusion FD by turning on the reset transistor M4, the voltage of the floating diffusion FD may be increased during charge transfer to expand the dynamic range of the output signal.

Although not illustrated in the equivalent circuit diagram of FIG. 11, a capacitor that capacitively couples the interconnection connected to the gate of the transfer transistor M1_0 and the floating diffusion FD3 and a capacitor that capacitively couples the interconnection connected to the gate of the transfer transistor M1_1 and the floating diffusion FD3 may be further added. With this configuration, it is possible to further increase the effect of increasing the voltage of the floating diffusion FD in the LG mode.

In the equivalent circuit diagram of FIG. 11, three reset transistors M5, M6, and M4 are connected in series between the power supply line and the floating diffusion FD, but the number of reset transistors connected between the power supply line and the floating diffusion FD may be four or more. With this configuration, the set values of the capacitance associated with the floating diffusion FD may be increased, and the operation mode may be further increased. In the present embodiment, since the readout circuit unit in the pixel is shared by the plurality of pixels 12, the influence on the circuit area due to the addition of the transistor is small compared to the case where the readout circuit unit is provided in each pixel. The number of reset transistors connected between the power supply line and the floating diffusion FD may be two as in the first to third embodiments.

FIG. 12 is a plan view illustrating a layout example of the pixels 12 in the photoelectric conversion device according to the present embodiment. FIG. 12 illustrates two pixel blocks 12B arranged in translational symmetry with respect to the horizontal direction (X direction). Each of the pixel blocks 12B includes two pixels arranged in the vertical direction (Y direction). For simplification of the drawing, FIG. 12 illustrates only patterns of active regions 112, 114, and 116 provided in a semiconductor substrate (semiconductor layer 110), a polycrystalline silicon layer constituting the gate electrodes of the transistors and the capacitor electrodes, a first interconnection layer, and a second interconnection layer. The active regions 112, 114, and 116 are represented by white regions surrounded by a solid line, and the cathode portions of the photoelectric conversion units PD_0 and PD_1 arranged in the active region 112 are represented by regions of a coarse dot pattern surrounded by a broken line. The polycrystalline silicon layer is represented by a region of a fine dot pattern surrounded by a solid line, and the gate electrode and the capacitor electrode are denoted by reference numerals indicating transistors and capacitors thereof. The first interconnection layer is represented by a hatched region surrounded by a solid line. The second interconnection layer is represented by a white region surrounded by a broken line. Further, a rectangular region marked with a cross mark represents a contact hole or a via-hole between layers for connecting the conductive members.

The active region 112 includes an active region 112a in which the photoelectric conversion units PD_0 and PD_1 and the transfer transistors M1_0 and M1_1 are arranged, and an active region 112b in which the reset transistor M4 is arranged. The active region 112a extends in the vertical direction and forms one region common to the plurality of pixel blocks 12B arranged in the vertical direction. The active region 112b is provided for each pixel block 12B so as to branch from the active region 112a. The active region 114 is a region in which the amplifier transistor M2 and the select transistor M3 are arranged and is provided for each pixel block 12B so as to be separated from the active region 112. The active region 116 is a region in which the reset transistors M5 and M6 and the capacitor C4 are arranged and is provided for each pixel block 12B so as to be separated from the active regions 112 and 114.

The first interconnection layer is arranged above the semiconductor layer 110 and the gate layer with an interlayer insulating film (not illustrated) interposed therebetween, and includes interconnections 120, 122, and 124. The interconnection 120 is electrically connected to the gate of the transfer transistor M1_0 via a via-hole provided in the interlayer insulating film. The interconnection 122 is electrically connected to the gate of the transfer transistor M1_1 via a via-hole provided in the interlayer insulating film. The interconnection 124 is electrically connected to the floating diffusion FD2 via a contact hole provided in the interlayer insulating film. The second interconnection layer is arranged above the interconnections 120, 122, and 124 with an interlayer insulating film (not illustrated) interposed therebetween, and includes interconnections 132 and 134. The interconnection 132 is electrically connected to the gate of the transfer transistor M1_0 via a via-hole provided in the interlayer insulating film and the interconnection 120. The interconnection 134 is electrically connected to the gate of the transfer transistor M1_1 via a via-hole provided in the interlayer insulating film and the interconnection 122.

The control signal P_TX_0 from the vertical scanning circuit 20 is supplied to each pixel block 12B via an interconnection (not illustrated) and is supplied to the gate of the transfer transistor M1_0 via the interconnection 132 and the interconnection 120. The control signal P_TX_1 from the vertical scanning circuit 20 is supplied to each pixel block 12B via an interconnection (not illustrated) and is supplied to the gate of the transfer transistor M1_1 via the interconnection 134 and the interconnection 122.

The interconnection 124 extends in a region in which the photoelectric conversion unit PD_0 is arranged and a region in which the photoelectric conversion unit PD_1 is arranged. The interconnection 120 is arranged in a region where the photoelectric conversion unit PD_0 is arranged in parallel with the interconnection 124. The interconnection 132 is provided so as to cover the interconnections 120 and 132 via an interlayer insulating film (not illustrated) and is electrically connected to the interconnection 120. The interconnection 122 is arranged in a region where the photoelectric conversion unit PD_1 is arranged in parallel with the interconnection 124. The interconnection 134 is provided so as to cover the interconnections 122 and 134 via an interlayer insulating film (not illustrated) and is electrically connected to the interconnection 122. When the first interconnection layer and the second interconnection layer are formed in this manner, an MIM-type capacitor forming the capacitor C2_0 is formed between the interconnection 124 and the interconnections 120 and 132. A MIM-type capacitor forming the capacitor C2_1 is formed between the interconnection 124 and the interconnections 122 and 134. As illustrated in, e.g., FIG. 12, the capacitor C4 may include a MOS capacitor formed between a capacitor electrode formed of a gate layer and a semiconductor layer.

Further, in the layout example of FIG. 12, the portion of the interconnection 124 facing the interconnection 120 and the portion of the interconnection 124 facing the interconnection 122 are arranged line-symmetrically with respect to a straight line connecting the floating diffusions FD in the horizontal direction. Further, the portion of the interconnection 124 opposed to the interconnection 132 and the portion of the interconnection 124 opposed to the interconnection 134 are arranged line-symmetrically with respect to the boundary of pixels adjacent in the column direction, that is, a straight line connecting the floating diffusions FD in the horizontal direction. Accordingly, since the capacitance value of the capacitor C2_0 and the capacitance value of the capacitor C2_1 are equal to each other, it is possible to equalize the increasing amount of the voltage of the floating diffusion FD and the pixel characteristics of the pixel 12 on the (2n-1)-th row and the pixel 12 on the 2n-th row.

As described above, according to the present embodiment, in the photoelectric conversion device, a circuit configuration for acquiring an image having a high dynamic range may be realized at low cost.

### Fifth Embodiment

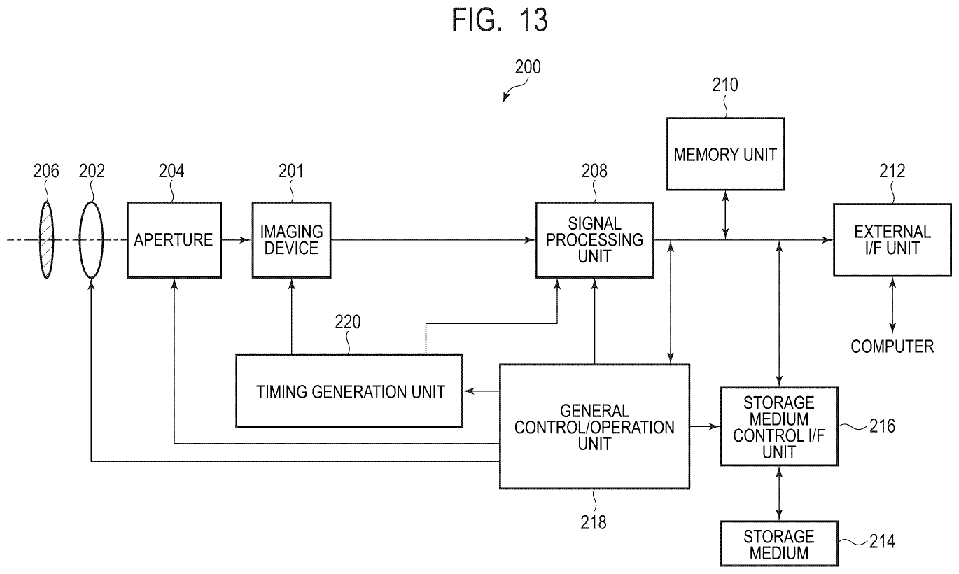

A photoelectric conversion system according to a fifth embodiment will be described with reference to FIG. 13. FIG. 13 is a block diagram illustrating a schematic configuration of the photoelectric conversion system according to the present embodiment.

The photoelectric conversion device 100 described in the first to fourth embodiments may be applied to various photoelectric conversion systems. Examples of applicable photoelectric conversion systems include digital still cameras, digital camcorders, surveillance cameras, copying machines, facsimiles, mobile phones, on-vehicle cameras, observation satellites, and the like. A camera module including an optical system such as a lens and an imaging device is also included in the photoelectric conversion system. FIG. 13 exemplifies a block diagram of a digital still camera as one of these.

The photoelectric conversion system 200 illustrated in FIG. 13 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 form an optical system that focuses light onto the imaging device 201. The imaging device 201 is the photoelectric conversion device 100 described in any of the first to fourth embodiments and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer different from the semiconductor layer on which the photoelectric conversion unit of the imaging device 201 is formed. In addition, the signal processing unit 208 may be formed on the same semiconductor layer as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photoelectric conversion system 200 or may be detachable.

The photoelectric conversion system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201 and outputs the processed image data. The signal processing unit 208 generates an image using the imaging signal.

As described above, according to the present embodiment, it is possible to realize a photoelectric conversion system to which the photoelectric conversion device 100 according to any of the first to fourth embodiments is applied.

### Sixth Embodiment

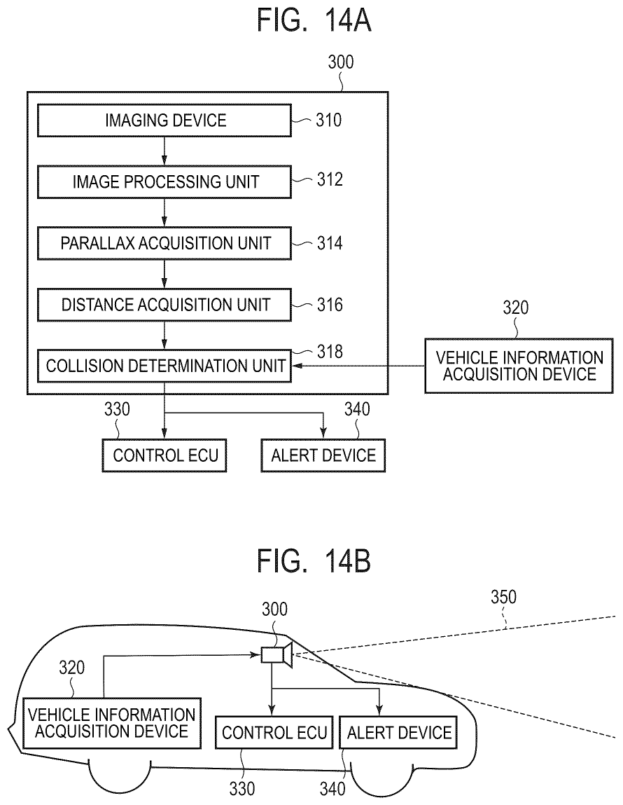

The photoelectric conversion system and a movable object according to a sixth embodiment will be described with reference to FIG. 14A and FIG. 14B. FIG. 14A is a diagram illustrating a configuration of a photoelectric conversion system according to the present embodiment. FIG. 14B is a diagram illustrating a configuration of a movable object according to the present embodiment.

FIG. 14A illustrates an example of a photoelectric conversion system related to an on-vehicle camera. The photoelectric conversion system 300 includes an imaging device 310. The imaging device 310 is the photoelectric conversion device 100 according to any one of the first to fourth embodiments. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to an object, and the like. The collision determination unit 318 may determine the collision possibility using any of the distance information. The distance information acquisition unit may be realized by dedicatedly designed hardware or may be realized by a software module. Further, it may be realized by a field programmable gate array (FPGA), application specific integrated circuit (ASIC), or the like, or may be realized by a combination of these.

The photoelectric conversion system 300 is connected to the vehicle information acquisition device 320 and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 14B illustrates the photoelectric conversion system in the case of capturing an image in front of the vehicle (imaging range 350). The vehicle information acquisition device 320 sends instructions to the photoelectric conversion system 300 or the imaging device 310. With such a configuration, the accuracy of distance measurement may be further improved.

Although an example in which control is performed so as not to collide with another vehicle has been described above, the present invention is also applicable to control in which automatic driving is performed so as to follow another vehicle, control in which automatic driving is performed so as not to protrude from a lane, and the like. Further, the photoelectric conversion system is not limited to a vehicle such as an own vehicle and may be applied to, for example, other movable objects (mobile devices), such as, for example, a ship, an aircraft, or an industrial robot. In addition, the present disclosure is not limited to the movable object and may be widely applied to equipment using object recognition, such as intelligent transport systems (ITS).

### Seventh Embodiment

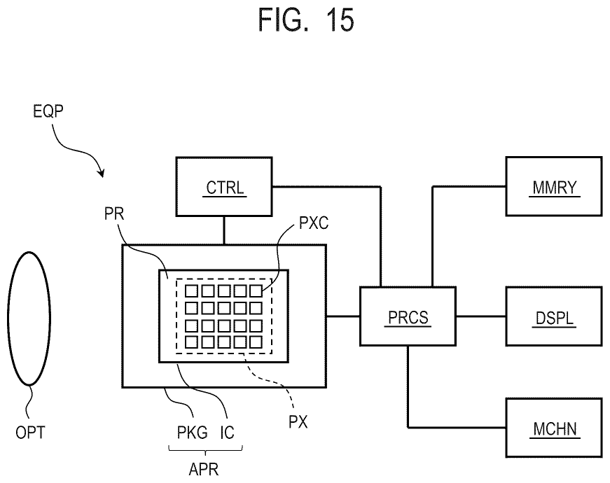

An equipment according to a seventh embodiment will be described with reference to FIG. 15. FIG. 15 is a block diagram illustrating a schematic configuration of an equipment according to the present embodiment.

FIG. 15 is a schematic diagram illustrating an equipment EQP including a photoelectric conversion device APR. The photoelectric conversion device APR has the function of the photoelectric conversion device 100 according to any of the first to fourth embodiments. All or part of the photoelectric conversion device APR is a semiconductor device IC. The photoelectric conversion device APR of the present example may be used as, for example, an image sensor, an AF (Auto Focus) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be arranged in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits in the second semiconductor chip may be column circuits corresponding to pixel columns of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (through silicon via (TSV)), an inter-chip interconnection by direct bonding of a conductor such as copper, a connection by a micro bump between chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as a static random access memory (SRAM) or a dynamic random access memory (DRAM), or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further include a storage device MMRY and a processing device PRCS separately from the storage circuit unit and the arithmetic circuit unit included in the photoelectric conversion device APR.

The equipment EQP illustrated in FIG. 15 may be an electronic device such as an information terminal (for example, a smartphone or a wearable terminal) having a photographing function or a camera (for example, an interchangeable lens camera, a compact camera, a video camera, and a monitoring camera). The mechanical device MCHN in the camera may drive components of the optical device OPT for zooming, focusing, and shutter operation. The equipment EQP may be a transportation device (movable object) such as a vehicle, a ship, or an airplane. The equipment EQP may be a medical device such as an endoscope or a CT scanner.

The mechanical device MCHN in the transport device may be used as a mobile device. The equipment EQP as a transport device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a moving device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present disclosure is not limited to the above embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present technology.

The circuit configurations of the pixels 12 illustrated in FIG. 2, FIG. 4, FIG. 6, and FIG. 11 are merely examples, and may be appropriately changed. For example, although one reset transistor is inserted between the reset transistor M5 and the floating diffusion FD in FIG. 2 and FIG. 6, two or more reset transistors may be inserted between the reset transistor M5 and the floating diffusion FD as in, e.g., FIG. 11. Although two photoelectric conversion units PD sharing a microlens are provided in FIG. 6, three or more photoelectric conversion units PD may share one microlens. Although two pixels share the readout circuit unit in FIG. 11, three or more pixels may share the readout circuit unit.

Further, in the above embodiments, the capacitors C2, C2A, C2B, C2_0, and C2_1 are formed using the first level metal interconnection layer and the second level metal interconnection layer, but the interconnection layers forming these capacitors may be changed as appropriate. The capacitors C2, C2A, C2B, C2_0, and C2_1 are not necessarily formed of two interconnection layers and may be formed of one interconnection layer or three or more interconnection layers.

The photoelectric conversion systems described in the fifth and sixth embodiments are examples of photoelectric conversion systems to which the photoelectric conversion device of the present disclosure may be applied, and the photoelectric conversion system to which the photoelectric conversion device of the present disclosure may be applied is not limited to the configuration illustrated in FIG. 13 and FIG. 14A.

According to the present invention, in a photoelectric conversion device, a circuit configuration for acquiring an image in a high dynamic range may be realized at low cost.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-115764, filed Jul. 19, 2024, and Japanese Patent Application No. 2025-065113, filed Apr. 10, 2025, which are hereby incorporated by reference herein in their entirety.

What is claimed is:

1. A photoelectric conversion device comprising:
a photoelectric conversion unit configured to generate charge in response to incidence of light;
a first charge holding portion;
a second charge holding portion;
a transfer unit configured to transfer the charge in the photoelectric conversion unit to the first charge holding portion in response to a control signal to a control node;
a switch configured to control a connection between the first charge holding portion and the second charge holding portion;
a capacitor configured by an electrostatic coupling between a first interconnection connected to the control node and a second interconnection arranged adjacent to the first interconnection and connected to the second charge holding portion; and
an output unit configured to output a signal corresponding to a potential of the first charge holding portion.

2. A photoelectric conversion device comprising:
a photoelectric conversion unit configured to generate charge in response to incidence of light;
a first charge holding portion;
a second charge holding portion;
a transfer unit configured to transfer the charge in the photoelectric conversion unit to the first charge holding portion in response to a control signal to a control node;
a switch configured to control a connection between the first charge holding portion and the second charge holding portion;
a capacitor of a MIM-type or a MOM-type connected between the control node and the second charge holding portion; and
an output unit configured to output a signal corresponding to a potential of the first charge holding portion.

3. The photoelectric conversion device according to claim 2, wherein the capacitor is configured by an electrostatic coupling between a first interconnection connected to the control node and a second interconnection connected to the second charge holding portion.

4. The photoelectric conversion device according to claim 1, further comprising:
a second photoelectric conversion unit configured to generate charge in response to incidence of light; and
a second transfer unit configured to transfer the charge in the second photoelectric conversion unit to the first charge holding portion.

5. The photoelectric conversion device according to claim 4, further comprising: a second capacitor connected between a control node of the second transfer unit and the second charge holding portion.

6. The photoelectric conversion device according to claim 5, wherein the second capacitor is configured by an electrostatic coupling between a second interconnection connected to the second charge holding portion and a third interconnection arranged adjacent to the second interconnection and connected to the control node of the second transfer unit.

7. The photoelectric conversion device according to claim 6, further comprising: a third capacitor configured by an electrostatic coupling between a first interconnection connected to the control node and the third interconnection.

8. The photoelectric conversion device according to claim 5, wherein the second capacitor is a MIM-type capacitor or a MOM-type capacitor connected between the control node of the second transfer unit and the second charge holding portion.

9. The photoelectric conversion device according to claim 4, wherein the photoelectric conversion unit and the second photoelectric conversion unit share a microlens.

10. The photoelectric conversion device according to claim 5,
wherein the photoelectric conversion unit and the transfer unit comprise a first pixel, and
wherein the second photoelectric conversion unit and the second transfer unit comprise a second pixel.

11. The photoelectric conversion device according to claim 10, wherein the capacitor and the second capacitor are arranged symmetrically with respect to a boundary between the first pixel and the second pixel.

12. The photoelectric conversion device according to claim 10, wherein the first pixel and the second pixel share the first charge holding portion, the second charge holding portion, the switch, and the output unit.

13. The photoelectric conversion device according to claim 1, further comprising:
a third charge holding portion; and
a second switch configured to control a connection between the second charge holding portion and the third charge holding portion.

14. The photoelectric conversion device according to claim 1, further comprising: a reset unit configured to reset the first charge holding portion to a predetermined potential.

15. The photoelectric conversion device according to claim 14, wherein the reset unit is connected between a power supply voltage node and the second charge holding portion.

16. The photoelectric conversion device according to claim 14, wherein the reset unit is connected between a power supply voltage node and the first charge holding portion.

17. The photoelectric conversion device according to claim 1, wherein a capacitance value of the capacitor is set so that a potential of the first charge holding portion is changed by a capacitive coupling with the first charge holding portion when the transfer unit is driven.

18. A photoelectric conversion system comprising:
the photoelectric conversion device according to claim 1; and
a signal processing device configured to process a signal output from the photoelectric conversion device.

19. A movable object comprising:
the photoelectric conversion device according to claim 1;
a distance information acquisition unit configured to acquire distance information to an object from a parallax image based on a signal from the photoelectric conversion device; and
a control unit configured to control the movable object based on the distance information.

20. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.

21. A method of driving a photoelectric conversion device including first and second photoelectric conversion units each configured to generate charge in response to incidence of light, first and second charge holding portions, a first transfer unit configured to transfer the charge in the first photoelectric conversion unit to the first charge holding portion in response to a control signal to a control node, a second transfer unit configured to transfer the charge in the second photoelectric conversion unit to the first charge holding portion in response to a control signal to a control node, a switch configured to control a connection between the first charge holding portion and the second charge holding portion, a first capacitor configured by an electrostatic coupling between a first interconnection connected to the control node of the first transfer unit and a second interconnection arranged adjacent to the first interconnection and connected to the second charge holding portion, a second capacitor configured by an electrostatic coupling between the second interconnection and a third interconnection arranged adjacent to the second interconnection and connected to the control node of the second transfer unit, and an output unit configured to output a signal corresponding to a potential of the first charge holding portion, the method comprising:
changing a potential of the first charge holding portion by a capacitive coupling by the first capacitor and transferring charge held in the first photoelectric conversion unit to the first charge holding portion, by driving the first transfer unit in a state in which the switch is on, to output a signal corresponding to a potential of the first charge holding portion from the output unit; and
changing the potential of the first charge holding portion by a capacitive coupling by the first capacitor and the second capacitor and transferring charge held in the first photoelectric conversion unit and the second photoelectric conversion unit to the first charge holding portion, by driving the first transfer unit and the second transfer unit in a state in which the switch is on, to output a signal corresponding to the potential of the first charge holding portion from the output unit.

22. The method of driving a photoelectric conversion device according to claim 21, wherein a length of a period of driving the first transfer unit is shorter than a length of a period of driving the first transfer unit and the second transfer unit.
